(19) United States
(12) Patent Application Publication
(10) Pub. No.: US 2024/0076185 A1
(43) Pub. Date: Mar. 7, 2024

(54) Nitric Oxide Generation

(71) Applicant: Third Pole, Inc., Waltham, MA (US)

(72) Inventors: Gregory W. Hall, Belmont, MA (US); Nathaniel G. Jackson, Lexington, MA (US); Benjamin J. Apollonio, Lunenburg, MA (US)

(73) Assignee: Third Pole, Inc., Waltham, MA (US)

(21) Appl. No.: 18/455,345

(22) Filed: Aug. 24, 2023

Related U.S. Application Data
(60) Provisional application No. 63/373,408, filed on Aug. 24, 2022.

(51) Int. Cl. C01B 21/24

(52) U.S. Cl. CPC C01B 21/24

(57) ABSTRACT

Systems, devices, and methods are provided for generating NO and delivering NO in controlled amounts. A system for generating nitric oxide (NO) is provided, and in some embodiments can include a converter configured to convert a source material to a NO-containing gas, at least one controller configured to independently control a conversion of the source material to the NO-containing gas and a delivery of the NO-containing gas to an inspiratory pathway, and one or more sensors configured to communicate, to the at least one controller, information related to the conversion of the source material to the NO-containing gas.

### RELATED APPLICATIONS

This application claims the benefit of and priority to U.S. Provisional Application Ser. No. 63/373,408, filed on Aug. 24, 2022, and the contents of which is incorporated herein by reference in its entirety.

### FIELD

The present disclosure relates to systems and methods for generating nitric oxide (NO) from a source material, such as N₂O₄.

### BACKGROUND

Nitric oxide has found to be useful in a number of ways for treatment of disease, particularly cardiac and respiratory ailments. Nitric oxide is a pulmonary vasodilator routinely used in a hospital setting to improve patient oxygenation. This molecule has the potential to provide similar benefits to users outside of a clinical setting as well. Exemplary out-of-hospital applications are for treating infection, preventing infection, treating altitude sickness and boosting athletic performance.

Previous systems for producing NO and delivering the NO gas to a patient have a number of disadvantages. For example, tank-based systems required large tanks of NO gas at a high concentration and pressure. When treatment using this system is paused, NO in the circuit stalls and converts into NO₂, requiring the user to purge the ventilation circuit before resuming ventilation.

### SUMMARY

The present disclosure is directed to systems, devices, and methods for generating NO and delivering NO in controlled amounts. The NO may be generated from donor molecules, N₂O₄, NO₂, and other sources. The generation process is configured to provide an adequate supply of NO for the delivery process and the delivery process ensures an accurate delivery of NO to an inspiratory flow. Various system architectures are presented for achieving accurate NO dosing in real time to an inspiratory flow.

A system for generating nitric oxide (NO) is provided, and in some embodiments can include a converter configured to convert a source material to a NO-containing gas, at least one controller configured to independently control a conversion of the source material to the NO-containing gas and a delivery of the NO-containing gas to an inspiratory pathway, and one or more sensors configured to communicate, to the at least one controller, information related to the conversion of the source material to the NO-containing gas. At least one of the one or more sensors includes a pressure sensor to measure a pressure related to gas released by the source material.

In some embodiments, the converter includes a first stage configured to convert the source material to an intermediate material and a second stage configured to convert the intermediate material to the NO-containing gas. In some embodiments, the source material is N₂O₄ and the intermediate material is NO₂. In some embodiments, the first stage of the converter includes a heater that is configured to heat the N₂O₄ to convert the N₂O₄ into NO₂. In some embodiments, the second stage of the converter includes ascorbic acid that is configured to convert the NO₂ into the NO-containing gas.

In some embodiments, the system further includes a dilution gas configured to dilute the NO₂ before exposure to the ascorbic acid in the second stage of the converter. In some embodiments, the dilution gas is ambient air.

In some embodiments, the controller is configured to receive the pressure measurement from the pressure sensor and use the pressure measurement as feedback to control the N₂O₄ heater. In some embodiments, the controller is configured to receive the pressure measurement from the pressure sensor and use the pressure measurement as feedback to an NO₂ flow controller to control the flow of NO₂ to the second stage of the converter.

In some embodiments, the first stage of the converter includes a heated chamber, and wherein the heated chamber includes a piston for pressure control in a gas headspace of the heated chamber. In some embodiments, the second stage of the converter including at least one of an antioxidant material, a nitroxyl material, an enzyme, radiation, and a catalytic reaction to convert the intermediate material into the NO-containing gas.

In some embodiments, the system further includes a mixing chamber configured to blend the NO-containing gas with gas in the inspiratory pathway prior to inhalation.

In some embodiments, the controller is configured to control delivery of the NO-containing gas to the inspiratory pathway such that a mass flow of the NO-containing gas into an inspiratory limb of a ventilator circuit is in proportion to a inspiratory gas mass flow rate.

In some embodiments, the one or more sensors further measure at least one of a temperature in the converter, a humidity condition in the converter, a pressure related to the converter, a gas flow rate, a NO concentration in the NO-containing gas produced by the converter, and reagent quantities of the source material.

In some embodiments, the one or more sensors further measure at least one of a temperature in the converter, a humidity condition in the converter, a pressure related to gas within the converter, a gas flow rate, a NO₂ concentration, a NO concentration in the NO-containing gas produced by the converter, and reagent quantities of the source material.

A method of generating nitric oxide (NO) is provided, and in some embodiments can include converting a source material, using a converter, to a NO-containing gas, measuring, using one or more sensors, a pressure related to gas in the converter, controlling, using at least one controller, a conversion of the source material to the NO-containing gas utilizing the measured pressure, and controlling, using the at least one controller and independent of the controlling of the conversion of the source material to the NO-containing gas, delivery of the NO-containing gas to an inspiratory pathway.

In some embodiments, converting the source material to the NO-containing gas includes converting the source material to an intermediate material and converting the intermediate material to the NO-containing gas. In some embodiments, the source material is N₂O₄. In some embodiments, the intermediate material is NO₂.

A NO generation and delivery device is provided where the NO gas generation and the NO delivery to the patient are decoupled. In some embodiments, the NO is generated by heating N₂O₄ into NO₂ and converting the NO₂ into NO. In some embodiments, NO₂ is converted/reduced to NO by an antioxidant material (e.g. ascorbic acid) or a nitroxyl material (e.g. TEMPO), or an enzyme (e.g., xanthine oxidoreductase). In some embodiments, NO₂ is reduced to NO by radiation (e.g., UV light). In some embodiments, the NO₂ is reduced to NO by a catalytic reaction (for example, heated metal forming metal oxides). In some embodiments, the NO is released from a material that releases NO over time, for example, using UV light-enhanced NO release.

### BRIEF DESCRIPTION OF THE DRAWINGS

The present disclosure is further described in the detailed description which follows, in reference to the noted plurality of drawings by way of non-limiting examples of exemplary embodiments, in which like reference numerals represent similar parts throughout the several views of the drawings, and wherein:

FIG. 1A depicts an exemplary graph showing the delivery of NO over time;

FIG. 1B depicts an exemplary graph showing three breaths at different locations (phase angles) of the NO concentration cycle;

FIG. 1C depicts an exemplary graph showing several breaths at various phase angles with respect to the NO concentration cycle;

FIG. 2A presents an exemplary graph of experimental data showing the effect of inspiratory limb length and the presence/absence of a humidifier on patient dose;

FIG. 2B presents an exemplary graph showing the NO concentration variation for tubing lengths of 2 feet, 4 feet and 6 feet;

FIG. 3 depicts an exemplary graph showing the NO concentration during a treatment where NO is introduced proportionally to the inspiratory flow;

FIG. 4A and FIG. 4B illustrate exemplary embodiments of a system for delivering NO in controlled amounts to a patient;

FIG. 5 depicts an exemplary flow chart of how a NO delivery controller can determine the correct quantity of NO to delivery to an inspiratory flow;

FIG. 6 illustrates an exemplary embodiment of a system delivery NO in controlled amounts to a patient using a source material with an intermediate step of NO₂ gas;

FIG. 7 depicts an exemplary embodiment of a system that dilutes NO gas after the NO generation step;

FIG. 8 depicts an exemplary embodiment of a NO delivery system 180 that sources NO from NO₂ and includes redundant components;

FIG. 9 depicts an exemplary embodiment of a system for controlling the pressure within the NO₂ gas derived from N₂O₄;

FIGS. 10A, 10B, and 10C illustrate exemplary graphs showing NO flow rate over time;

FIG. 11 depicts an exemplary embodiment of a system for controlling the pressure within the NO₂ gas derived from N₂O₄;

FIG. 12 depicts an exemplary embodiment of a system that converts NO₂ to NO within a pressurized reservoir prior to controlled release;

FIG. 13 depicts an exemplary control scheme for the system shown in FIG. 12;

FIG. 14 depicts an exemplary embodiment of a flowchart showing a feedforward control scheme for delivering NO to an inspiratory flow;

FIG. 15 depicts an embodiment of a NO delivery system that sources NO from N₂O₄;

FIG. 16 depicts an exemplary embodiment of a system that converts NO₂ to NO in an independent step prior to storing product gas as NO in a pressurized reservoir;

FIG. 17 depicts an exemplary embodiment of a system that stores pressurized NO₂ and converts NO₂ to NO as it is released from the system;

FIG. 18 depicts an exemplary embodiment of a system that includes a N₂O₄ reservoir that is actively heated;

FIG. 19 depicts an exemplary embodiment of a NO delivery system that sources NO from a N₂O₄ reservoir;

FIG. 20 depicts an exemplary embodiment of a system that sources NO from N₂O₄ and delivers constant concentration NO to a patient;

FIG. 21 depicts an exemplary NO generation and delivery system that decouples NO generation from NO delivery;

FIGS. 22A and 22B illustrate exemplary embodiments of expansion chambers;

FIG. 23 depicts an exemplary embodiment of a system that utilizes a soft-walled N₂O₄ container;

FIG. 24 depicts an exemplary embodiment of a system that sources NO₂ from a gas cylinder;

FIG. 25 depicts an embodiment of a system that sources NO₂ gas from a compressed gas cylinder;

FIG. 26 depicts an embodiment of a NO delivery system that derives the NO gas from a source of NO₂ gas;

FIG. 27 depicts an exemplary embodiment of a system that combines the dilution vessel and the converter;

FIG. 28 depicts an embodiment of a system that generates a variable flow of NO from a source of N₂O₄;

FIG. 29 depicts an embodiment of a system that generates a continuously variable flow of NO from a source of N₂O₄;

FIG. 30 depicts an embodiment of a system that generates NO from a N₂O₄ source;

FIG. 31 depicts an exemplary embodiment of a system with a pressurized conversion chamber;

FIG. 32 depicts an embodiment of a NO delivery system that sources NO from N₂O₄;

FIG. 33 depicts an embodiment of a NO delivery system with a purging feature; and

FIG. 34 depicts an exemplary embodiment of a NO delivery device with purge feature.

While the above-identified drawings set forth presently disclosed embodiments, other embodiments are also contemplated, as noted in the discussion. This disclosure presents illustrative embodiments by way of representation and not limitation. Numerous other modifications and embodiments can be devised by those skilled in the art which fall within the scope and spirit of the principles of the presently disclosed embodiments.

### DETAILED DESCRIPTION

The following description provides exemplary embodiments only, and is not intended to limit the scope, applicability, or configuration of the disclosure. Rather, the following description of the exemplary embodiments will provide those skilled in the art with an enabling description for implementing one or more exemplary embodiments. It will be understood that various changes may be made in the function and arrangement of elements without departing from the spirit and scope of the presently disclosed embodiments.

Specific details are given in the following description to provide a thorough understanding of the embodiments. However, it will be understood by one of ordinary skill in the art that the embodiments may be practiced without these specific details. For example, systems, processes, and other elements in the presently disclosed embodiments may be shown as components in block diagram form in order not to obscure the embodiments in unnecessary detail. In other instances, well-known processes, structures, and techniques may be shown without unnecessary detail in order to avoid obscuring the embodiments. Figures depicting architectures forgo the details of also depicting cabling and control elements to provide focus on the innovation.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed but could have additional steps not discussed or included in a figure. Furthermore, not all operations in any particularly described process may occur in all embodiments. A process may correspond to a method, a function, a procedure, a subroutine, a subprogram, etc. When a process corresponds to a function, its termination corresponds to a return of the function to the calling function or the main function.

Subject matter will now be described more fully with reference to the accompanying drawings, which form a part hereof, and which show, by way of illustration, specific example aspects and embodiments of the present disclosure. Subject matter may, however, be embodied in a variety of different forms and, therefore, covered or claimed subject matter is intended to be construed as not being limited to any example embodiments set forth herein; example embodiments are provided merely to be illustrative. The following detailed description is, therefore, not intended to be taken in a limiting sense.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

It should be understood that reference to a “flow controller” is inclusive of mass flow controllers and combinations of flow sensors, pressure sensors and valves that can be utilized to control a mass flow rate.

The terms “converter” or “reducer” is utilized to refer to system components or methods that convert NO₂ gas into NO gas. In some embodiments, the conversion is a reduction reaction that removes an oxygen atom from the NO₂. Examples of NO₂ to NO conversion technologies include but are not limited to chemical means such as a reducing agent (e.g. antioxidants such as wet ascorbic acid) or a nitroxyl radical (e.g. TEMPO), or an enzyme (e.g. xanthine oxidoreductase), radiated energy (e.g. ultraviolet light), thermal (e.g. elevated temperatures), and catalytic means (e.g. heated metal). The term “NO₂ scrubber” is inclusive of methods that remove NO₂ from an NO gas stream. Example NO₂ scrubber materials include but are not limited to soda lime and metal organic framework materials. In applications where the NO₂ conversion process is not sufficiently efficient or as a safety mitigation, an NO₂ scrubber is utilized after a conversion process in some embodiments.

Nitric oxide is a therapeutic gas that relaxes smooth muscle causing blood vessel dilation within the lungs when inhaled. This effect lowers the pulmonary vascular resistance, decreases the load on the right heart and increases blood oxygenation.

Various embodiments depicted include a reservoir component. It should be understood that “reservoir” is intended to mean a volume of gas. The reservoir may be a discrete component such as a gas cylinder, a cavity within another component (e.g. a manifold) or simply a volume of tubing that connects one component to another.

Medicinal grade NO can be sourced from a variety of means. In some embodiments, NO is sourced from a compressed gas cylinder. In some embodiments, NO is generated on site from air using an electrical plasma. Other approaches involve deriving NO from one or more NO-donor molecules or chemical reactions on site (e.g. Nitric Oxide-Releasing Carboxymethylcellulose, Nitric Oxide-Releasing Hyaluronic Acid, Nitric Oxide-Releasing Hyperbranched Polymers, Nitric Oxide-Releasing Alginates, Nitric Oxide-Releasing Polyurethanes, Nitric Oxide-Releasing Cyclodextrins, Nitric oxide-releasing hyperbranched polyaminoglycosides, Nitric Oxide-Releasing Macromolecular Scaffolds, Nitric Oxide-Releasing Hyperbranched Polyamidoamines, Nitric Oxide-Releasing Liposomes, Nitric Oxide-Releasing Chitosan Oligosaccharides, Silica Particle-Doped Nitric Oxide-Releasing Polyurethane, Nitric Oxide-Releasing Alkyl-Modified Poly(amidoamine) Dendrimers, Nitric Oxide-Releasing Silica Nanoparticles, Photoinitiated Nitric Oxide-Releasing Tertiary S-Nitrosothiol-Modified Xerogels, structurally deformed nitrite-type layered double hydroxide materials). In one exemplary embodiment, nitrate/nitrite/nitroso compounds are exposed to enzymes that break the compounds down, releasing NO molecules. In some embodiments, dinitrogen tetroxide (N₂O₄) is heated to release NO₂ which is then reduced to NO.

Nitric oxide is delivered for a variety of indications via many different treatment modalities. For example, NO can be prescribed as either a target inhaled concentration or a number of molecules per unit time (e.g., mg/hr, mg/hr/kgIBW). In many instances, NO is delivered simultaneously with an adjacent therapy. For example, in some embodiments, a patient is periodically respirated with a manual resuscitator (i.e., bag). In some embodiments, NO is delivered as a pulse during a portion of the respiratory cycle (e.g., inspiration). In some embodiments, NO is introduced continuously to an inspiratory flow stream (e.g., ventilator inspiratory stream or anesthesia inspiratory stream).

Dose accuracy during NO therapy can be very important. The FDA guidance for NO delivery recommends the NO dose be accurate to within 20% with 10% of the inhaled volume being allowed to deviate as much as +50/−100% off target. Patients decrease endogenous NO production in the presence of exogenous NO and can experience rebound conditions (i.e., spontaneous pulmonary vasoconstriction) when the NO dose is significantly and suddenly altered. In some instances, these rebound conditions can be life-threatening. Hence, consistent and accurate delivery of NO is important for ensuring safe patient treatment.

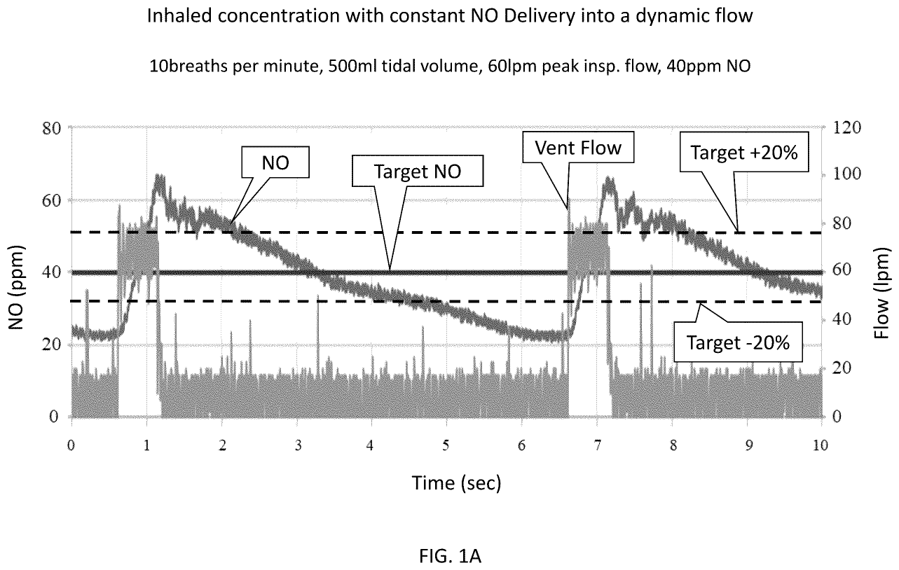

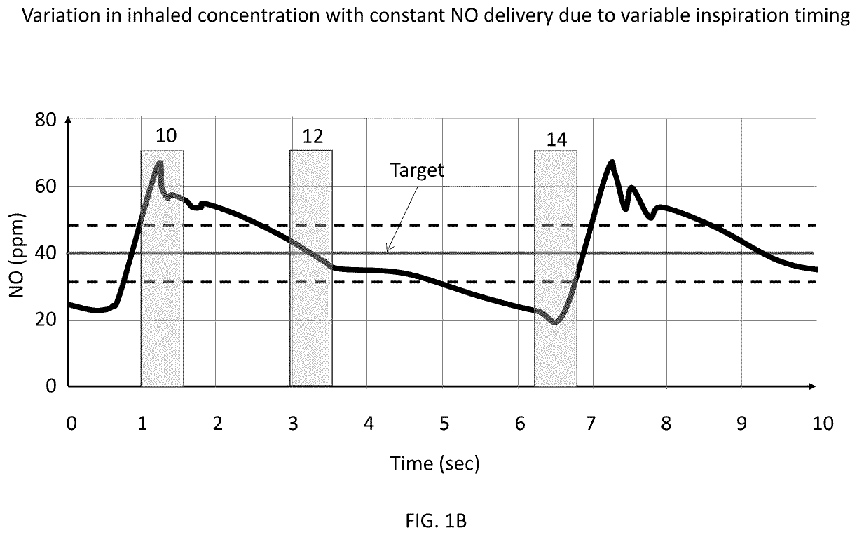

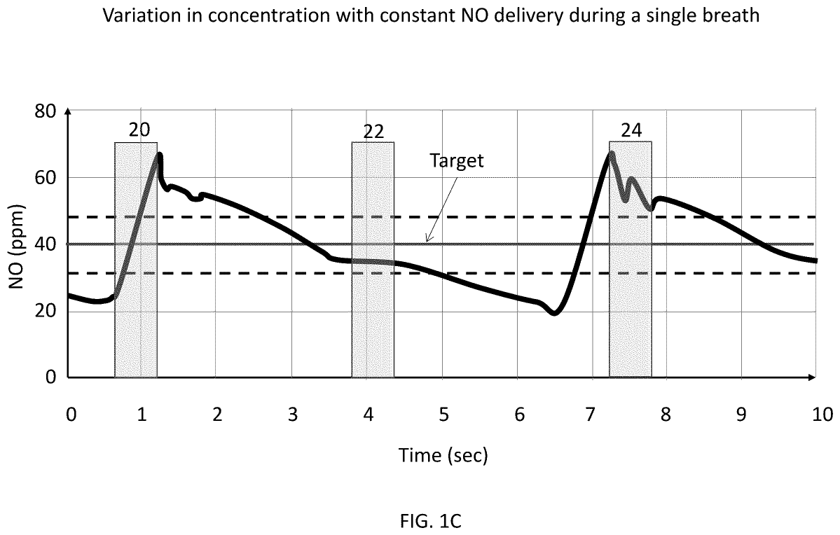

The consistency of inhaled NO concentration varies with NO delivery approach. When NO is delivered at a constant flow rate and concentration into a dynamic inspiratory flow, the concentration within the inspired gas can vary significantly. FIG. 1A depicts an exemplary graph showing the delivery of NO over time, whereby NO is delivered to a 22 mm diameter inspiratory limb of a ventilated patient at a constant concentration and flow rate. In this example, the ventilator settings are for 10 breaths per minute, a 500 ml tidal volume, a peak flow of 60 lpm and a bias flow (i.e., the inspiratory flow between breaths) of 4 lpm. The target inhaled NO concentration is 40 ppm. The average NO concentration over time is roughly 40 ppm. However, the actual concentration of gas inhaled by the patient varies from 22 ppm at the beginning of the breath to 66 ppm at the end of the breath. Concentration varies within the breath with late inspired gas having a concentration of roughly three times the concentration of initial-inspired gas. It is also readily apparent that greater than 10% of the volume inhaled is outside the +/−20% concentration rage.

The actual concentration of NO inhaled by the patient can depend on the phase relationship between the NO concentration wave and the patient breathing cycle. FIG. 1B depicts an exemplary graph showing three breaths 10, 12, 14 at different locations (phase angles) of the NO concentration cycle. The breath 10 is synchronized with the peak NO concentration in the cycle resulting in a mean inhaled concentration of 58 ppm. The breath 12 occurs as the concentration crosses the 40 ppm target so that the patient inhales the target concentration, on average. The breath 14 coincides with the low concentration point in the respiratory cycle so that an average of 24 ppm is inhaled. This phase dependence is related to the volume of tubing between the point of NO injection and the patient. If the NO was injected at a constant rate at the patient, the point of low concentration would coincide with inhalation in time (i.e., phase angle of 0) because the NO would be diluted by the fast inspiratory flow at the patient. As the point of NO injection moves further away from the patient, the phase angle increases and the patient begins by breathing overdosed bias flow gas before the diluted, faster flowing gas reaches the patient. The duration of each breath is shown to be the same in FIG. 1B, but it should be understood that the duration of a breath depends on the inspiratory flow rate and can vary. Despite the variation in the breath duration that would typically occur, the fact that variation in mean concentration between breaths is still a valid concern.

During inhalation, regions of the lung are filled to varying degrees as the lung expands. At the beginning of inspiration, portions of the lung that are lower with respect to gravity are more fully collapsed and receive a greater portion of the inhaled gas. When the concentration of NO in an inspired gas is constant, lower regions of the lung receive a higher dose of NO because they receive more inhaled gas. For example, when a patient is sitting or standing, the parts of the lung closest to the diaphragm receive more fresh gas (i.e. more NO) than the upper portions of the lung. It follows that the inspired volume and NO dose delivered to different regions of the lung is not uniform even when the inhaled NO concentration is constant. Due to the differential filling of the lung, the concentration delivered throughout the lung can be a challenge to predict when the inhaled NO concentration varies during inspiration.

FIG. 1C depicts an exemplary graph showing three breaths 20, 22, 24 at various phase angles with respect to the NO concentration cycle. The breath 20 begins at a concentration of 26 ppm and ends at a concentration of 66 ppm. The breath 22 receives a constant concentration of 36 ppm. The breath 24 begins at a concentration of 66 ppm and ends at a concentration of 54 ppm. These variations in concentration within the inspired tidal volume, superimposed on the differential lung filling described above, result in additional dosing variation between regions of the lung. This can be of particular concern, for example, when treating lung infections, where the concentration of NO must exceed a minimum bactericidal/viricidal/fungicidal dose level to be effective. If portions of the inspired tidal volume are under-dosed with NO, for example, then the dependent lung regions which receive more of the tidal volume may be underdosed.

Despite the fluctuations in NO concentration within the inspiratory limb over time, NO delivery is consistent from breath to breath in a given periodic respiratory system. In an exemplary ventilator NO treatment, a care giver initiates treatment by selecting a target NO dose of 20 ppm. They wait for a period of time (e.g., minutes) to see whether or not the patient responds favorably (e.g., SpO₂ increases). If the patient does not respond favorably, the care giver increases the dose (e.g., 40 ppm) and waits again. Based on the variable dilution of a constant flow of NO into a variable inspiratory gas stream, as depicted in FIG. 1A, the actual mean concentration inhaled by the patient could be as much as 50% above or below the target. In some cases, this can be clinically acceptable since the care giver can empirically determine a setting of the NO device that produces the desired patient response. In one exemplary case, the device could be set to 40 ppm and the patient is actually receiving a dose-equivalent to 20 ppm and there is a satisfactory level of pulmonary vasodilation. Modern day NO treatment can be somewhat accepting of these variations in delivered dose because the dose is tailored to each patient treatment, which includes the effects of phase angle due to the NO delivery method and inspiratory limb set-up.

The presence of large fluctuations in NO concentration within an inspiratory stream is often masked by the slow electrochemical NO sensors typically used by clinical NO delivery devices. These sensors typically have t90 times of 30 seconds or more, rendering care givers unaware of the actual NO dose being delivered. An electrochemical sensor in each of the treatment cases depicted in FIG. 1B would report a time-average of 40 ppm NO even though the patient might actually be receiving +/−50% of the indicated concentration.

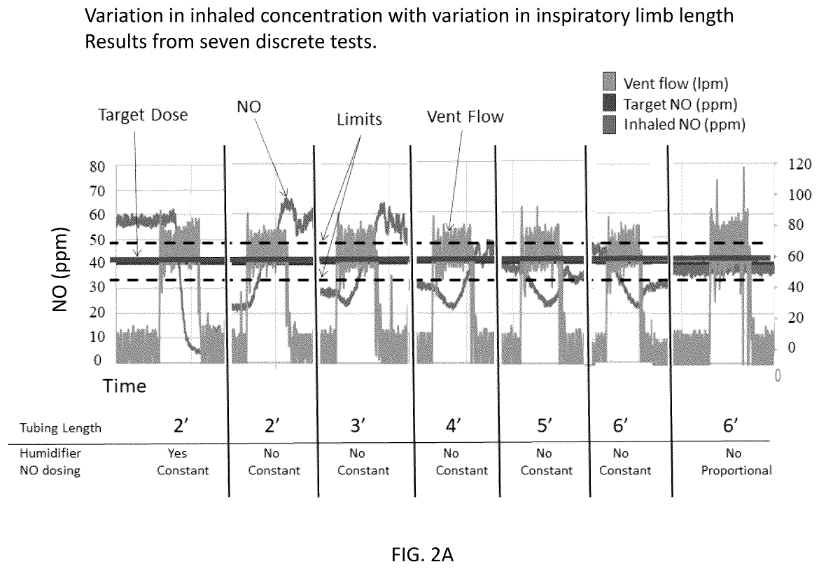

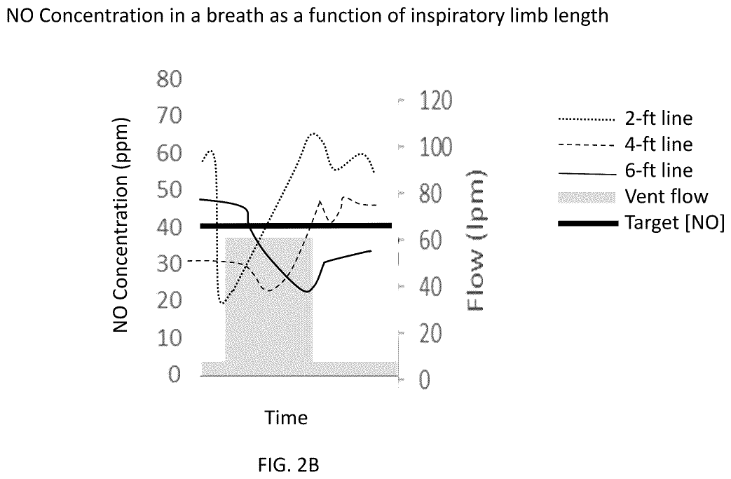

FIG. 2A presents an exemplary graph of experimental data showing the effect of inspiratory limb length and the presence/absence of a humidifier on patient dose when NO is delivered to an inspiratory limb at a constant flow rate. The internal diameter of the inspiratory limb tubing was 22 mm. The ventilator settings are for 10 breaths per minute, a 500 ml tidal volume, a peak flow of 60 lpm and a bias flow of 4 lpm. The first breath in the series was measured with a 2-foot inspiratory line and no humidifier. The patient initially breaths overdosed gas (58 ppm) that has filled the inspiratory limb during the bias flow of the ventilator cycle. As the inspiration flow rate increases, under-dosed gas begins to reach the patient so that the gas concentration at the end of the breath is minimally dosed with 5 ppm NO. When a humidifier is added to the system, the range of concentration within the tidal volume decreases from 5-58 ppm to 22-64 ppm, with the minimum NO concentration reaching the initial portion of the lung. The humidifier adds additional volume to the inspiratory circuit which provides additional time for the NO and inspiratory gas to mix, hence the decrease in the range of concentrations within the tidal volume. As additional inspiratory limb length is added, the range of NO concentration within the breath decreases due to the increased mixing volume/transit time. It is also evident that the phase of the patient is shifting as the inspiratory lengthens. This is most evident by looking at the timing of the minimum NO concentration with respect to each inspiratory flow pulse. With a 2-foot inspiratory limb, the minimum NO concentration coincides with the beginning of the breath. With a 4-foot inspiratory limb, the minimum NO concentration coincides with the mid-point of the breath. With a 6-foot inspiratory limb, the minimum NO concentration coincides with the end of the breath. This shift in concentration with respect to the breath is what is meant by the phase between patient and NO concentration. In one embodiment, the phase angle in radians is calculated as:

Phase angle=tₘᵢₙ/resp period*2π

Where tₘᵢₙ=The elapsed time from the beginning of inspiration to the point of minimum NO concentration, and Resp period=the duration of the respiratory period.

Referring again to FIG. 2A, the breath rate in the example is 10 breaths per minute, so the breath period is 60 (sec/min)/10 (breaths/min)=6 sec. The time of minimum NO concentration for 2-foot tubing with humidifier is at the beginning of inspiration (i.e. time=0 sec). Thus, the phase angle of the minimum NO concentration is 0 radians (0 degrees). For the 4-foot tubing, the minimum NO concentration occurs 1 second into the 2-second inspiratory event. Using the phase angle equation, the phase angle=1 sec/6 sec*2π=0.52 rad=30 degrees. This concept of phase angle between respiratory cycle and NO concentration cycle can help illustrate the effect of various treatment parameters and configurations on delivered dose.

The final breath depicted in FIG. 2A is the result of delivery NO proportionally to the inspiratory flow. In this case, the NO concentration within the inspiratory limb remains constant. The timing of inspiration and length on inspiratory limb have no bearing on the delivered dose because all inspiratory gas is dosed to the target concentration.

FIG. 2B presents an exemplary graph that superimposes the NO concentration variation for tubing lengths of 2 feet, 4 feet and 6 feet. The ventilator in this exemplary experiment operated with 4 lpm bias flow, 60 lpm peak flow, 22 mm tubing and a humidifier.

Clinical Risks

The simplicity of a system that delivers a constant molar NO delivery rate brings with it significant clinical risk. The phase relationship between the NO concentration variation and patient inspiratory cycle varies with inspiratory limb volume, inspiratory limb length, whether or not a humidifier is utilized, bias flow level, pressure settings, tidal volume, and respiratory rate. Thus, seemingly minor and routine adjustments to the ventilator settings and/or inspiratory limb configuration can have profound effects on the level of NO being delivered to a patient and the concentration distribution within the patient's lungs and airway.

The following are a few exemplary clinical scenarios:

Scenario 1: A patient is set to 20 ppm NO in a constant NO delivery system. A humidifier is added to the breathing circuit. The humidifier has an internal volume of 250 ml (when full) and the additional 0.5 m of tubing has an internal volume of 190 ml. The total increase in inspiratory limb volume of 440 ml shifts the phase of the patient with respect to the NO concentration wave by 0.4 seconds (for a flow rate of 66 lpm). In a worst-case scenario, a patient receiving an actual equivalent dose of 20 ppm starts receiving a dose of 40 ppm after the humidifier is added. This level of change exceeds limits defined in the FDA guidelines and could lead to a clinically adverse event.

Scenario 2: A patient requires more oxygenation. A care giver increases the respiratory rate of a ventilator from 10 bpm to 20 bpm with no changes to the inspiratory limb configuration. The portion of the inspired gas inhaled by the patient changes and the delivered NO dose to the patient changes from an average of 40 ppm to an average of 60 ppm.

Scenario 3: A patient is receiving constant NO delivery during a ventilator treatment. A care giver notices that the inspiratory limb is contacting the floor. The caregiver shortens the 22 mm ID inspiratory limb from 2 m to 1.5 m to lift the tube off the floor, decreasing the inspiratory limb volume by 190 ml. This change in inspiratory volume, shifts the phase of the patient by 0.25 sec, resulting in a 20 ppm change in average dose.

When the actual dose to a particular portion of the breath is examined, instead of only looking at the average, the deviations in dose are even more significant, as demonstrated in FIG. 1B. Patients receiving NO therapy become dependent on the exogenous NO. Sudden changes to the exogenous NO delivery level can create a rebound reaction within the patient, whereby the pulmonary vasculature suddenly contracts. This suddenly increases the load on the right heart and decreases pulmonary blood flow which can result in adverse effects on SpO₂ level. A shift on NO concentration delivered can also move a region of high NO concentration within the lung from a healthy region that is able to uptake oxygen to an unhealthy region of the lung. NO treatment of unhealthy regions of the lung can result in vasodilation in a region that does uptake oxygen well, resulting in shunting within the lung and decreased SpO₂.

Exemplary Solutions

In some embodiments, a mixing chamber is utilized to blend NO with the inspired gas prior to inhalation. The mixing chamber adds volume to the NO delivery path, increasing transit time and the potential for NO loss. Adding volume to a ventilation circuit cannot be done whenever a care-giver desires. At the beginning of treatment with a ventilator, the inspiratory limb volume is characterized by the ventilator to quantify any existing leaks and the compressibility of the ventilation circuit. A mixing chamber would need to be present at the time of this ventilator set-up for accurate ventilation treatment since adding additional volume mid treatment could result in altered ventilation treatment or ventilator errors.

In some embodiments, an approach to NO delivery is to deliver a mass flow of NO to the inspiratory limb of a ventilator circuit in proportion to the inspiratory mass flow rate. In other words, for example, to achieve a 20 ppm (parts per million) concentration within the inspired gas, the NO device needs to deliver 20 NO molecules with every 999,980 molecules of inhaled gas (NOTE: 20+999,980=1 million). As the rate of delivery of the inhaled gas increases, so too must the rate of delivery of NO gas to maintain the same concentration of NO in inhaled gas.

Another way of describing proportional flow is by maintaining a constant dilution ratio, where the dilution ratio is the ratio of NO mass flow rate to inspiratory mass flow rate. In some embodiments, the ratio of NO mass flow rate to inspiratory gas flow rate before dilution is held constant. In some embodiments, constant concentration NO is introduced to the inspiratory flow at a flow rate that is proportional to the inspiratory flow. In some embodiments, the NO gas is introduced to the inspiratory flow at a constant flow rate and the concentration of NO within the injected gas is varied as a function of the inspiratory flow rate. In some embodiments, both NO concentration and NO flow rate are varied to achieve a proportional number of moles of NO introduced to the mass flow rate of the combined flows (inspiratory and NO flow).

In some embodiments, a NO treatment controller monitors for inspiratory events. In some embodiments, the controller monitors one more sensors (e.g. pressure, flow rate) to detect an inspiratory event (e.g. inspiration). In some embodiments, the controller receives one or more of a flow signal, a pressure signal, and event trigger signal from an external device to identify when to release NO into the inspiratory flow. In applications where pulsed NO delivered, the controller opens the flow controller in response to the detected inspiratory event. In systems with a variable flow controller (e.g. a proportional valve), the controller varies the flow rate of NO out of the device over time. In some embodiments, the flow rate is varied such that it is proportional with the inspiratory flow rate, as indicated by an internal sensor or external device. In some embodiments, the flow rate of NO exiting the device is at a constant rate. In some embodiments, the controller varies the flow controller orifice size to compensate for a drop in pressure corresponding with rapid low of gas from a gas reservoir. In some embodiments, the controller controls a binary flow valve to define the duration of the NO pulse. In some embodiments, the controller controls a binary flow valve (e.g. on/off) the NO flow rate decays over time as the pulse is delivered due to a loss of pressure in the gas reservoir.

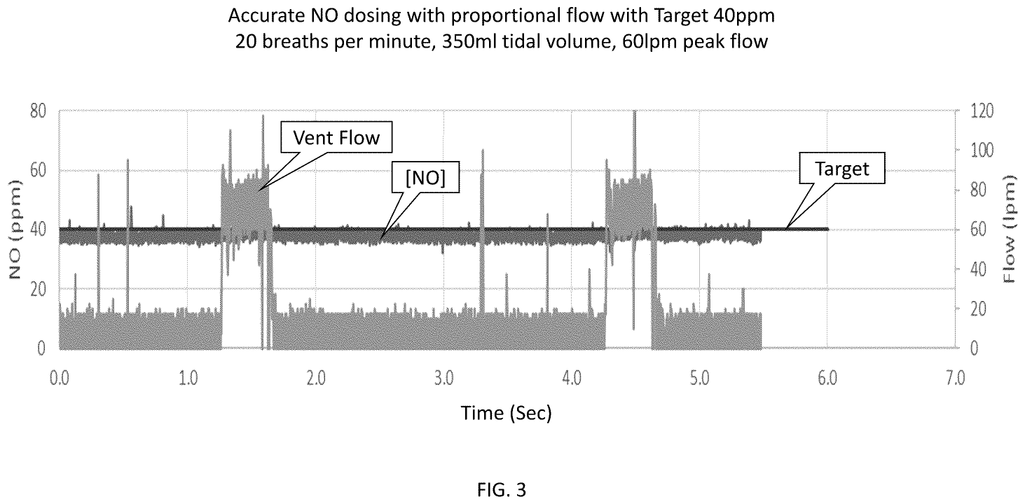

FIG. 3 depicts an exemplary graph showing the NO concentration during a treatment where NO is introduced proportionally to the inspiratory flow. In the example, a ventilator was set to 20 breaths per minute (bpm), 350 ml tidal volume, a bias flow of 4 lpm and a max flow rate of 60 lpm. Constant concentration NO was delivered at a constant dilution ratio to achieve the target NO concentration within the inspiratory limb. This achieved a constant concentration of NO within all of the gas within the inspiratory limb. In this scenario, there is no phase relationship between the patient respiration and concentration variation because the NO concentration is constant. The delivered dose to the patient is not dependent on the breath rate, tidal volume, bias flow, inspiratory tubing length and presence/absence of a humidifier, greatly improving the safety and accuracy of the NO treatment.

NO Generation

Delivery of NO molecules in proportion to an inspiratory flow requires system architectures that accommodate the strengths and limitations of each NO generation method. NO generation methods include, but are not limited to, generation of NO from plasma, generation of NO from N₂O₄, use of nitric oxide releasing solution (NORS), nitric oxide releasing powder, nanoparticles containing NO, ultraviolet light release of NO from a polymeric scaffold, pH release of NO from a polymeric scaffold, and others. Some solutions initially begin with NO₂ gas (e.g. gas cylinders) or create NO₂ gas (e.g., boiling of N₂O₄). This can be used as NO₂ gas is stable on its own and when it is diluted with air. Other solutions create NO gas directly. Solutions that first generate NO₂ have an intermediate step that converts the NO₂ to NO. This can be done via one or more of strong reducing agents (e.g., ascorbic acid), through catalytic reactions at elevated temperature (e.g., heated molybdenum), reduction with UV light and other approaches.

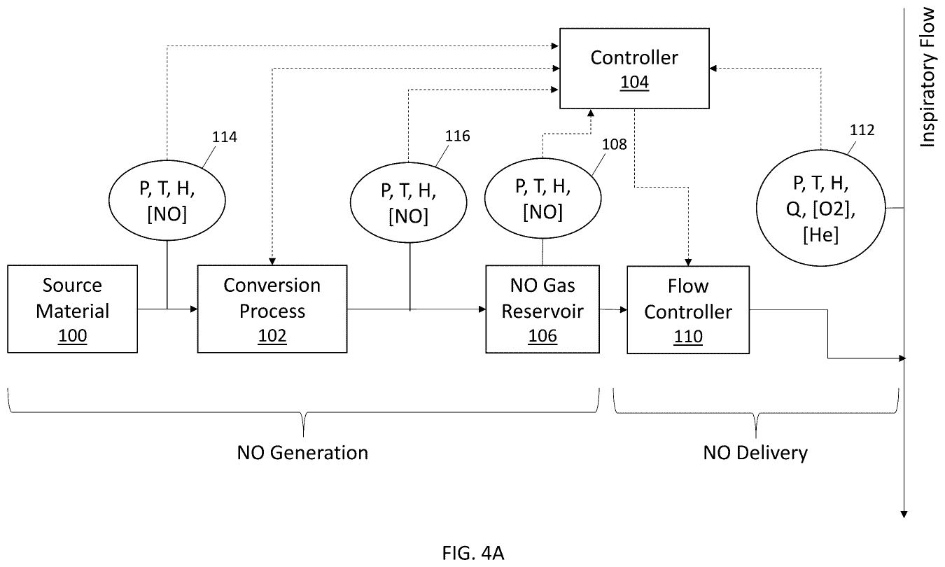

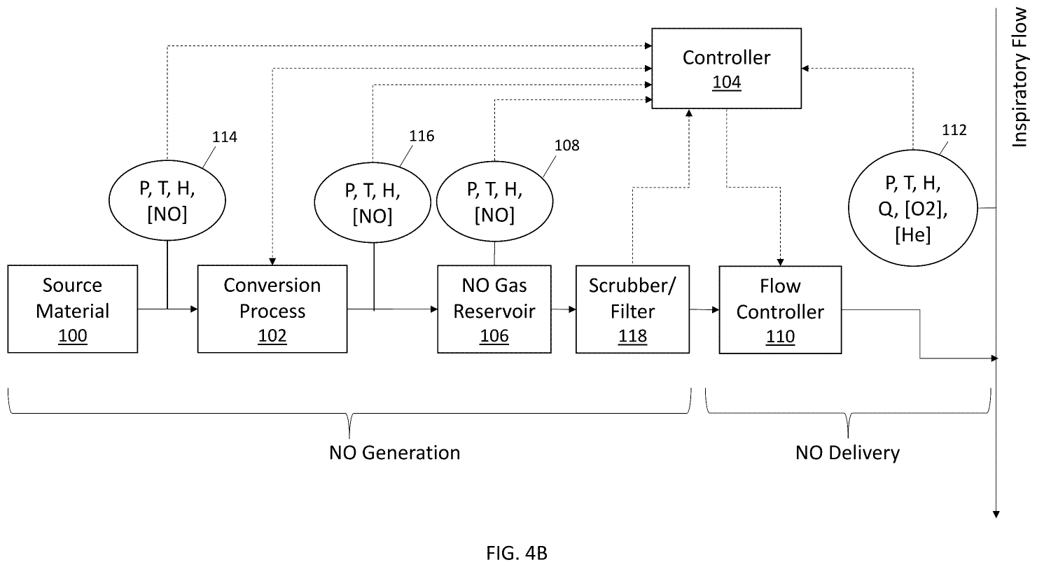

FIG. 4A illustrates an exemplary embodiment of a high-level depiction of the various steps involved with delivery of NO in controlled amounts to a patient. A source material 100 can be a solid, liquid, or gas that can generate/release NO in a controllable manner. In some embodiments, the source material can be at least one of a liquid and a solid. In some embodiments, the information is provided to a controller 104 related to the source material using, for example, one or more sensors 114 (e.g., temperature, humidity, pressure, source material composition, source material age or usage, etc.) to assist in accurate management of the NO generation process, and it will be understood that these sensors related to the source material can be optional. Source material can vary, and can include but is not limited to donor molecules, N₂O₄, NO₂ and other sources.

A conversion process 102 controlled by a controller generates NO from the source material 100. The conversion process can be performed using a variety of components. For example, the conversion process can be one that involves chemicals, heat, or a catalyst. In some embodiments, the conversion process can include antioxidant material (e.g. ascorbic acid) or a nitroxyl material (e.g. TEMPO), or an enzyme (e.g., xanthine oxidoreductase). In some embodiments, the conversion process can include the use of radiation (e.g., UV light). In some embodiments, the conversion process includes a catalytic reaction (for example, formation of metal oxides). In some embodiments, the conversion process includes a heater component that transforms a first gas into a second gas.

In some embodiments, the conversion process 102 provides feedback to a controller 104 of the status of the process using, for example, one or more sensors 116 (e.g., temperature, humidity, pressure, flow rate, NO concentration, reagent quantities, etc.) to assist in accurate management of the NO generation process. It will be understood that any number of sensors can be used to communicate information about the conversion process to the controller, and that these sensors are also optional depending on the needs of the system. The conversion process can include a single stage configured to convert the source material into a NO-containing gas, or the conversion process can include a plurality of stages with intermediate materials such that the final stage of the conversion process results in a NO-containing gas. In some embodiments, the conversion process can optionally include components that allow the product of any stage of the conversion process to be diluted as necessary. Information relating to each stage of the conversion process can be communicated to the controller using sensors or other components such that the controller can control each stage of the process and any dilution if needed.

Gaseous NO is then stored in a reservoir 106. In applications where the NO generation process is slow (i.e., not instantaneous, taking more than a few tens of milliseconds to generate NO), the reservoir must have enough volume to contain sufficient NO to supply to address spikes in NO demand, such as boluses of NO delivered during a rapid inspiratory event. In some embodiments, NO gas is stored in contact with NO₂ adsorbent material (e.g., soda lime) to maintain NO purity. In some embodiments, NO gas is stored at elevated temperature to slow the rate of oxidation in NO₂. In some embodiments, the NO generation process involves multiple steps. In one exemplary embodiment, N₂O₄ is first converted to NO₂ gas and then the NO₂ gas is converted to NO gas.

In some embodiments, the controller manages the product gas temperature at a target level to prevent NO₂ formation by modulating a heater in thermal contact with the product gas pathway. In some embodiments, a temperature sensor (e.g., thermocouple, thermistor, IR camera) measures the temperature of either the product gas or the product gas pathway to provide feedback to the temperature controller. In some embodiments, the product gas is heated by resistive cartridge heaters, controlled by the controller. In some embodiments, the properties of the NO product gas (e.g., temperature (T), pressure (P), humidity (H), NO concentration ([NO])) can be measured by one or more sensors 108 and that information is provided to the controller. It will be understood that any number of sensors can be used to communicate information about the conversion process to the controller, and that these sensors are also optional depending on the needs of the system. In some embodiments, the pressure of the NO product gas is measured by a sensor in fluid communication with a reservoir that stores NO product gas. In some embodiments, sensor measurements (e.g. pressure, NO concentration) serve as an input to an algorithm that calculates NO loss to one or more of NO oxidation and interaction with device materials (e.g., reducer material, scrubber material, tubing, etc.) In some embodiments, the concentration of NO product gas is measured.

In some embodiments, the NO concentration is measured immediately upstream of a flow controller 110 that delivers NO gas to an inspiratory flow. In some embodiments, the concentration of NO is measured within a reservoir that houses NO. The NO concentration information is sent to the controller to serve as input into a dosing algorithm that determines the amount of NO to add to the inspiratory flow to achieve a target inspired concentration. In some instances, the dilution ratio is varied by the controller to achieve the target inhaled NO concentration based on the actual concentration of NO product gas. In some embodiments, the controller determines a quantity of NO to release in a bolus to deliver a target number of moles of NO molecules to one or more of an inspiratory flow or a patient.

In some embodiments, the concentration of NO in the inspired gas is measured at or near the patient. Measurements of NO concentration at or near the patient can account for changes in NO concentration that can occur between the NO injector and the patient. For example, more NO is oxidized into NO₂ when inhaled oxygen levels are high. In another example, the NO concentration will be higher at the patient when the inspiratory limb or delivery device is short, owing to a shorter transit time. When the inspired NO concentration is measured and fed back to the controller, the controller can adjust the amount of NO being one or more of generated and delivered to compensate for these variations to more accurately achieve the target inhaled concentration.

In some embodiments, the controller measures gas properties within the external flow that will receive the NO gas (e.g. inspiratory flow rate (Q), temperature (T), pressure (P), humidity (H), oxygen concentration ([O2]), helium concentration ([He])) using one or more sensors 112. These gas properties include one or more of temperature, humidity, oxygen concentration, nitrogen concentration, helium concentration, pressure, and flow rate. The system can utilize any combination or subset of sensors to communicate any combination or subset of information to the controller that relates to the inspiratory flow. The controller can use this information in a variety of ways. In some embodiments, this information is supplied to the controller to calculate the mass flow rate of NO required to accurately dose the external flow. By knowing these properties of the product gas, the controller can more accurately calculate the mass flow rate of inspired gas and thereby more accurately calculate the amount of NO to introduce to the inspiratory stream. For example, a mass flow controller in an inspiratory limb is calibrated with air, which is roughly 21% oxygen and 78% nitrogen. In a HELIOX treatment, where a fraction of the inspired gas is helium (e.g., 70%), the density of the inspired gas is less and the calibration of the inspired gas flow sensor will not be accurate. By measuring the concentration of helium and oxygen in the inspired gas, the controller can determine the density of the inspired gas and automatically adjust the inspired gas mass flow sensor calibration accordingly to measure the inspired gas mass flow accurately and determine the correct amount of NO to introduce to the inhaled gas flow. In some embodiments, the user enters the inspired gas mixture into the NO delivery device controller (e.g. % O2, % N2, % He) and the controller uses this information in combination with mass flow meter data to determine the quantity of NO to deliver.

The sensors 108, 114, 116 shown in FIG. 4A can be used to measure gas concentration and related information at various locations through the system. This information communicated to the controller can be used to control various components of the system to achieve target NO concentrations/amounts to be delivered into the inspiratory flow, and can be used for additional measurements and calculations throughout the system. Any subset of the sensors 108, 114, 116 can be present in the system depending on the system needs. In some embodiments, the controller can have stored or calculate information relating to one of target mass flow rate of NO required, NO source type, NO material source status, target NO source pressure, target NO source temperature, etc. that can be communicated to the conversion process.

FIG. 4B illustrates an exemplary embodiment of a high-level depiction of the various steps involved with delivery of NO in controlled amounts to a patient. The system shown in FIG. 4B is similar to the system shown in FIG. 4A, but includes additional optional components. For example, the system can include a scrubber/filter component 118 that comprises one or more scrubbers and one or more filters. In some embodiments, an NO₂ scrubber is utilized after the conversion process to remove excess NO₂ from the gas. In some embodiments, an activated carbon scrubber can be used to remove furfural and other VOCs from the gas. In some embodiments, one or more optional particle filters can be used to remove particulate matter that may be present in the NO-containing product gas. Possible sources of particulate matter include the NO source material, the converter and the scrubber.

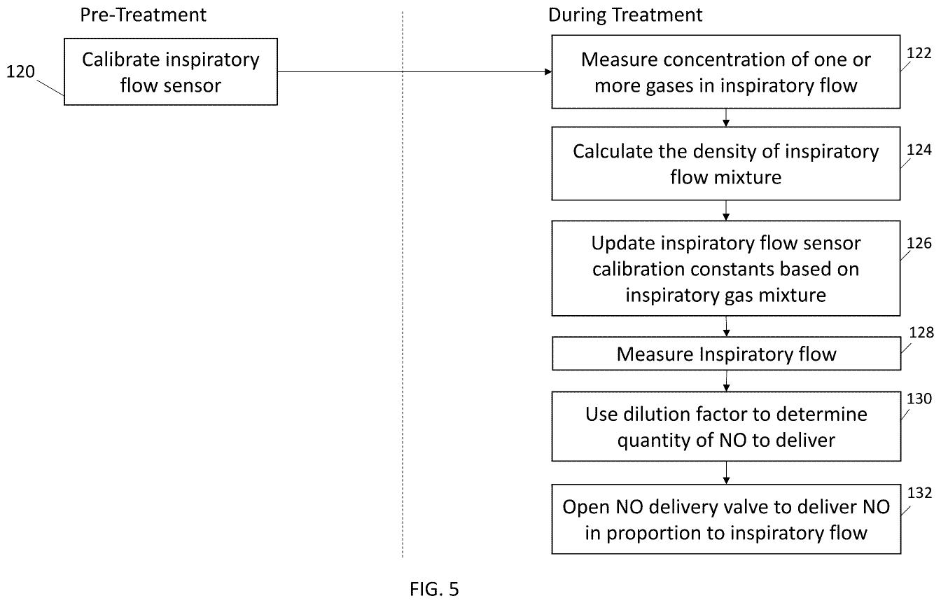

FIG. 5 depicts an exemplary flow chart of how a NO delivery controller can determine the correct quantity of NO to delivery to an inspiratory flow. Prior to treatment, the inspiratory flow sensor is calibrated with a known gas (e.g. air, nitrogen) in step 120. During treatment, the device controller utilizes one or more gas sensors (e.g. helium concentration sensor, oxygen concentration sensor, nitrogen concentration sensor) to identify the inspiratory gas mixture (step 122). For example, if Helium concentration is 250,000 ppm and oxygen concentration is 250,000 ppm, the system can assume that the balance (50%) is nitrogen. The density of the inspired gas is calculated (step 124) and the inspiratory flow sensor calibration is updated according to the current inspiratory gas density (step 126). The controller uses the corrected inspiratory flow sensor calibration to measure the mass flow within the inspiratory limb (step 128). A dilution factor is utilized to determine the scaling factor between inspiratory flow measurements and the amount of NO to deliver (step 130). NO is delivered in proportion to the inspiratory flow (step 132).

In some embodiments, the controller strives to achieve a constant concentration of NO within the external flow. In some embodiments, NO is delivered as a bolus during specific events within the external flow (e.g., inspiratory events indicated by surges in the external flow).

In some embodiments, the NO generation method generates very high concentrations of NO (e.g., thousands of ppm to tens of thousands of ppm to pure NO). The system can include features to allow for the delivery of gas in extremely small quantities. In some embodiments, the system can enable NO injection flow controller operation within an acceptable range by diluting the NO gas. In some embodiments, the gas is diluted with air. In some embodiments, the gas is diluted is an inert gas (e.g., nitrogen). Dilution can be applied to NO₂ gas within the system and/or NO gas within the system.

In some embodiments, microfluidic techniques are applied to deliver very low quantities of high concentration NO. For example, some embodiments have micron-scale gas pathways to deliver NO to a dilution or inspiratory flow. In some embodiments, a chip utilized for controller gas flow includes a valve or pumping mechanism (e.g. piezoelectric). In some embodiments, a diaphragm pump is used to micro dose a gas flow with high concentration NO.

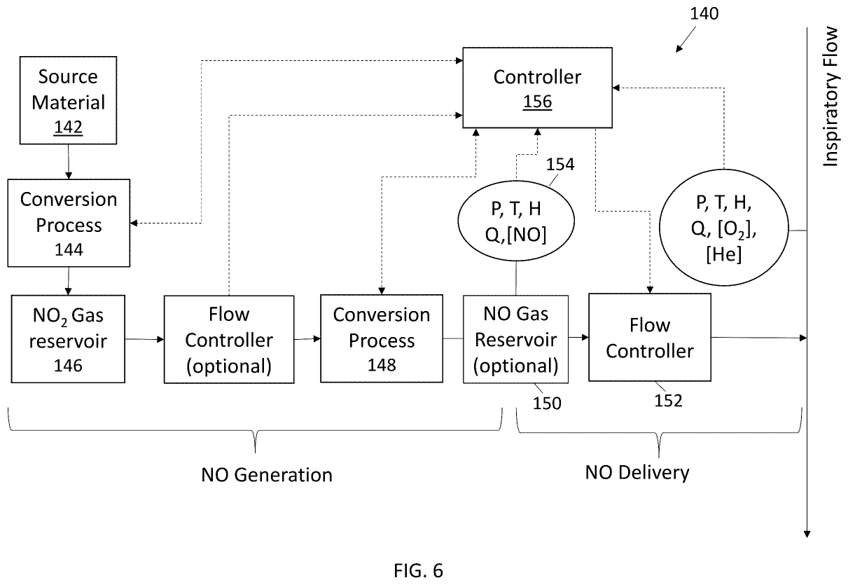

FIG. 6 depicts an exemplary embodiment of a system 140 that utilizes a conversion process to convert a source material 142 into NO₂ gas. The source material 142 is converted into NO₂ gas using a conversion process 144. The NO₂ gas is stored in a reservoir or accumulator 146 and controllably released into a second conversion process 148 that converts NO₂ into NO. NO gas is passed to a flow controller 152 that modulates the release of NO gas into an inspiratory gas stream. In some embodiments, NO gas accumulates within a reservoir or accumulator 150, as shown. A reservoir can be comprised of a discrete storage component or simply the pneumatic tubing that conveys the NO gas. One or more sensors 154 are used to measure properties of the NO gas before the injector include one or more of temperature (T), pressure (P), humidity (H), flow rate (Q), and NO concentration ([NO]). Various information from sensors and flow controllers can be communicated to a controller 156, which can also communicate control information to the conversion processes and flow controllers.

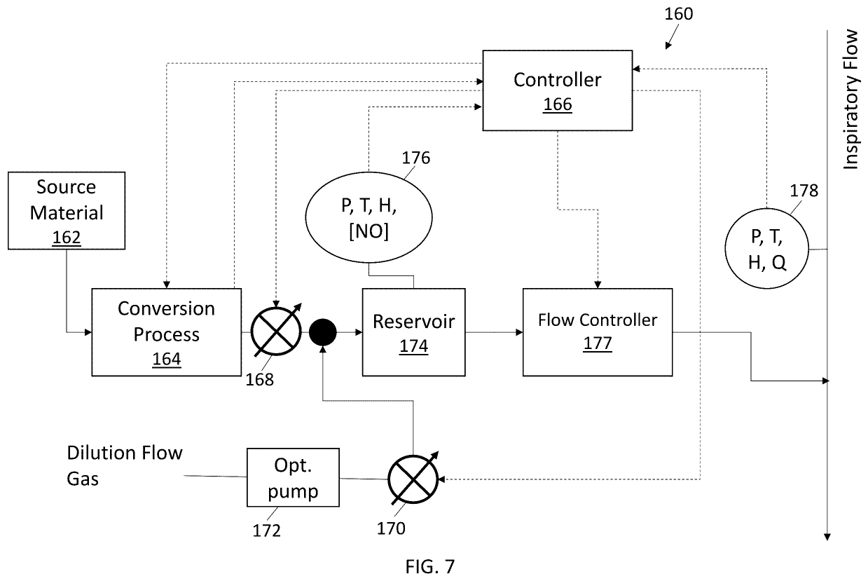

FIG. 7 depicts an exemplary embodiment of a system 160 that dilutes NO gas after the NO generation step. NO is generated from a source material 162 in a conversion process 164 that receives information from a controller 166 (e.g., activation signal, target mass flow rate of NO required, NO source type, NO material source status (new, used), NO target source pressure, target NO source temperature, etc.) The conversion process also sends information back to the controller 166 (e.g., NO temperature, NO concentration, NO pressure). NO gas produced is released from the conversion process through a flow controller 168 and is diluted by a dilution gas (e.g., air, nitrogen, helium, argon, xenon etc.). A flow controller 170 regulates the flow rate of dilution gas according to inputs from the controller 166. In some embodiments, the controller 166 measures the mass flow rate of the inspiratory gas to determine a target NO product gas mass flow rate to introduce to the inspiratory flow to achieve a target inhaled NO concentration. The inspiratory gas mass flow rate may be measured directly or be calculated based one or more of a volumetric flow rate, pressure, temperature, and humidity measurement, depending on what parameters are known or held constant by design. The controller 166 then determines the amount of NO mass flow and dilution gas mass flow required to achieve the target injected NO mass flow rate in order to achieve the target inspiratory flow NO concentration.

In some embodiments, a pump 172 is utilized to generate the flow in the dilution gas. In some embodiments, the dilution gas is sourced from a pressurized source, eliminating the need for a pump. In some embodiments, a single pump draws dilution gas and NO/NO₂ gas through a blender. In some embodiments, the pressure of the pressurized source serves as an input to the control of the dilution gas flow controller. The dilution step can be made before or after a NO₂ scrubbing step.

Continuing with FIG. 7, blended NO and dilution gas are stored in a reservoir 174. In some embodiments, one or more of the concentration, pressure, temperature and humidity of the NO gas are monitored with one or more sensors 176, as shown. The pressurized gas passes through a flow controller 177 that is controlled by the treatment controller 166. The treatment controller varies the diluted NO gas flow through the flow controller according to the inspiratory mass flow rate to achieve a target NO concentration in the in the inspiratory flow. The inspiratory flow rate is either measured directly or inferred/calculated based on one or more of inspiratory flow parameters (e.g., pressure (P), temperature (T), humidity (H), and volumetric flow rate (Q) using one or more sensors 178, inspiratory gas composition ([O2], [N2], [He], etc.)), and the target patient dose. Essentially, pressure, temperature, humidity and gas composition measurements enable the controller to calculate the gas density. The mathematical product of gas density and volumetric flow rate yields the mass flow rate. In some embodiments, the treatment controller provides a NO gas flow that is directly proportional to the inspiratory gas flow to achieve a constant concentration of NO in the inspiratory flow. In some embodiments, diluted NO gas is pulsed to align in time with inspiratory events (e.g., inspiration). Inspiration can be detected by the treatment controller via one or more sensors in communication with the inspiratory gas flow, sensors that measure patient activity (e.g., diaphragm contraction, intra-airway pressure, temperature below the nose, humidity below the nose, etc.), or via communication with an external device that is generating the inspiratory flow.

Purging

In some embodiments, the NO delivery system clears the pneumatic pathways within the NO device and delivery device with a non-NO-containing gas to prevent NO aging within the system. In some embodiments, purging is done upon the termination of NO therapy. In some embodiments, purging is done between patient breaths. In some embodiments, purging is done after system calibration. Purging prevents NO oxidation into NO₂, which could ultimately be delivered to the patient. In some embodiments, the dilution gas (e.g., air, nitrogen) is utilized to purge the system. In some embodiments of a system that generates NO from a source material in the form of NO₂ or N₂O₄, some conduits containing pure NO₂ formed from N₂O₄ do not require purging because pure NO₂ is stable.

Redundancy

In some embodiments, one or more components of the system are duplicated for redundancy. In some embodiments, a second NO₂ or NO feature is engaged when there is a failure (e.g., gas leak, liquid leak, clog, pump failure, reservoir empty, valve failure) within a first NO₂ or NO feature. In some embodiments, the system includes duplicate N₂O₄ reservoirs to ensure continuous NO delivery in the event that a first N₂O₄ reservoir becomes empty. In some embodiments, a system that derives NO from N₂O₄ can deliver NO to more than one patient treatment at a time utilizing more than one NO generator at a time. In some embodiments, a system that derives NO from N₂O₄ can deliver NO to more than one treatment mode (e.g. ventilator, manual resuscitator, CPAP, etc.) at a time utilizing more than one NO generator or gas reservoir at a time.

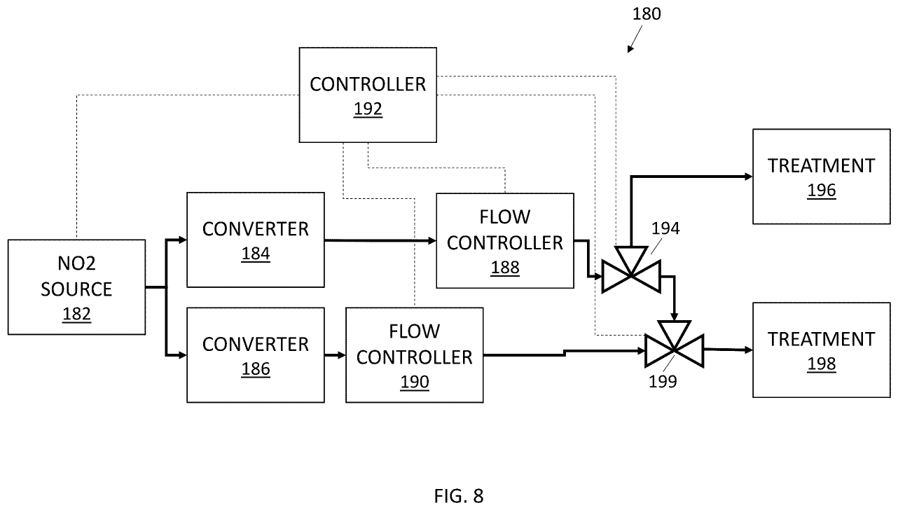

FIG. 8 depicts an exemplary embodiment of a NO delivery system 180 that sources NO from NO₂ and includes redundant components. A NO₂ source 182 (e.g., NO₂ gas cylinder, N₂O₄ heating system) delivers NO₂ to two independent converters 184, 186 that product NO from the NO₂. Gas exiting the converters 184, 186 passes through two independent flow controllers 188, 190 that can vary the mass flow rate of NO gas delivered to a treatment. A controller 192 utilizes a three way valve 194 at the end of the first (upper) pathway to select between a first treatment 196 (e.g., a manual resuscitator) and a second treatment 198 (e.g., a ventilator inspiratory limb). The controller utilizes a three-way valve 199 at the end of the second (lower) pathway to select which NO source shall be delivered to the second treatment 198. In some embodiments, the controller 192 switches from one converter path to another converter path in the event of a fault condition (e.g., converter expired, flow controller failure, etc.), thereby providing continuous NO therapy to a patient

Generation of NO from N₂O₄

Generation of NO from a source material in the form of N₂O₄ involves heating N₂O₄ to form NO₂ gas. Higher temperatures result in higher gas pressure when the N₂O₄ is in a sealed, rigid or semi-rigid container. The NO₂ gas is then converted to NO by one or means (e.g. a reducing agent such as ascorbic acid. Using this approach, a small amount of liquid N₂O₄ can produce large amounts of NO. A drawback with this approach is that the process of heating N₂O₄, generating NO₂, and scrubbing the NO₂ is a slow process. In some embodiments, gas sensors are utilized to measure the inspired NO concentration and provide feedback to the NO generation controller. In some embodiments, slow electrochemical sensors are utilized to measure the gas concentration. The combination of slow NO gas sensing with slow N₂O₄ heating/cooling results in prolonged periods of time to achieve the target inhaled NO dose. In some cases, the time from treatment initiation to achieving indicated dose accuracy can be up to 20 minutes or longer. It will be understood that the actual concentration inhaled by the patient can vary wildly from the concentration indicated by an electrochemical NO sensor due to the slow t90 time of the sensor rendering oblivious to transient concentration fluctuations.

Dose accuracy improvements can be attained by decoupling the NO generation function of the N₂O₄ heating from the NO delivery function in order to deliver tightly controlled amounts of NO to a variable inspiratory flow. In some embodiments, NO₂ is converted to NO based on a time average of NO demand (e.g., patient minute volume) and NO is delivered to the patient based on real time measurement of patient demand for NO (e.g. inspiratory limb flow rate).

In some embodiments, the conditions within the N₂O₄ chamber are controlled to achieve a target pressure within the NO₂ gas head space, rather than a temperature of the N₂O₄. In some embodiments, conditions within the N₂O₄ chamber are controlled to achieve a target density of NO₂ gas (a function of temperature and pressure). In some embodiments, the N₂O₄ chamber is comprised of a disposable container of N₂O₄. In some embodiments, the N₂O₄ chamber is comprised of a combination of disposable and reusable components that are reversibly connected to form a chamber while also permitting container replacement. In some embodiments, the reusable portion of the chamber includes one or more of a chamber wall, one or more pressure sensors, and one or more flow controllers (e.g. passive, active).

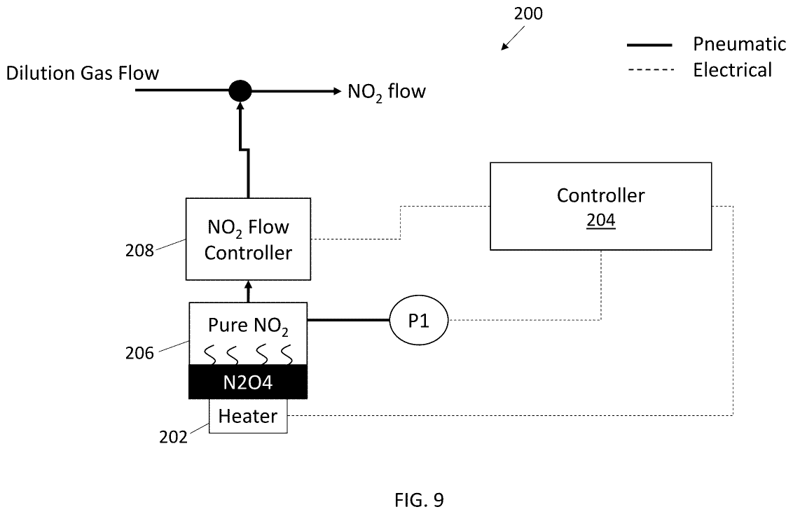

FIG. 9 depicts an embodiment of a system 200 that includes functionality for controlling the pressure within the NO₂ gas derived from N₂O₄. A N₂O₄ heater 202 is modulated by a controller 204 to maintain a target pressure of NO₂ gas in the headspace of a reservoir 206, as indicated by a pressure sensor (P1) in fluid communication with the headspace. A step reduction in NO₂ pressure after delivery of a bolus of NO₂ to the dilution flow is detected via the pressure sensor and the power to the heater is increased to increase the rate of NO₂ formation and make up for lost NO₂. So long as the temperature is high enough that there is sufficient NO₂ pressure in the headspace that the system can always address demand for transient increases in NO₂ flow and recover to the target pressure prior to the next transient event (e.g., an inspiratory event), the system can rely on a flow controller 208 to adjust its effective orifice size to deliver the required mass flow rate of NO₂ downstream.

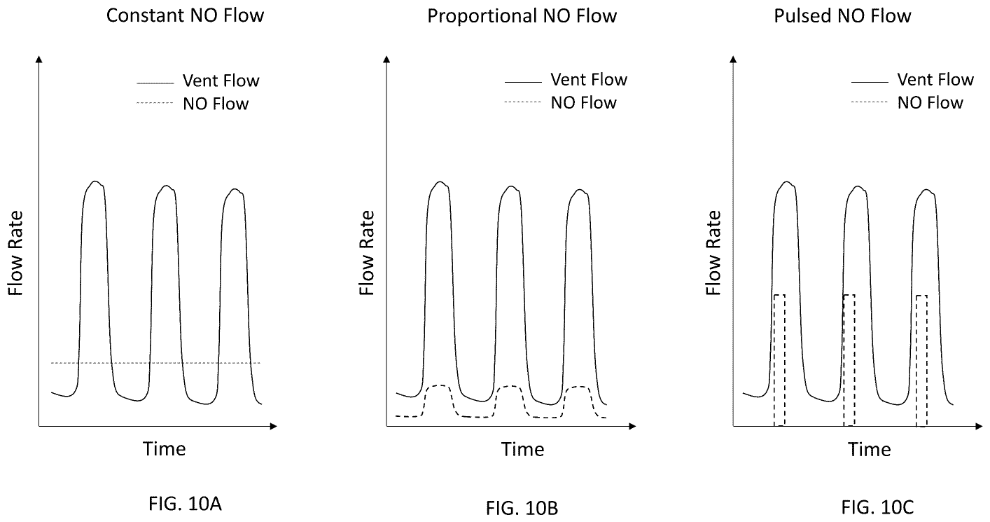

Pure NO₂ gas released from the system is diluted (optional) and converted to NO (not shown) prior to introduction to an inspiratory flow. In some embodiments, released gas is delivered continuously to an inspiratory flow. Continuous NO delivery can be delivered at a constant flow rate, as shown in FIG. 10A, or proportional to the inspiratory flow, as shown in FIG. 10B. In some embodiments, gas is released intermittently to form pulses of NO that are delivered to an inspiratory limb or directly to a patient, as shown in FIG. 10C.

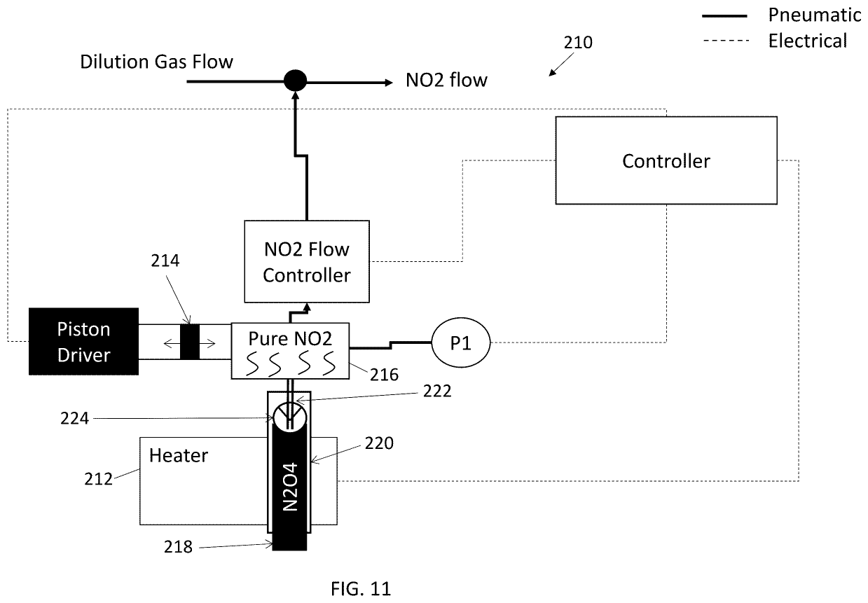

FIG. 11 depicts an embodiment of a system 210 that generates a flow of NO₂ gas, similar to that of FIG. 9, but with faster pressure control. Rather than relying solely on heating of the N₂O₄ using a heater 212, which takes seconds to minutes to create changes in NO₂ gas pressure, a piston chamber and piston 214 are included to enable the system to control NO₂ pressure within the NO₂ chamber 216 independent of N₂O₄ temperature during transient events requiring rapid release of gas. A similar piston-based approach can be utilized within a chamber of NO gas instead of NO₂ gas. In one scenario, a patient breath is detected that requires a bolus of NO. As NO₂ exits the head space and the pressure decreases, the piston is advanced towards the NO₂ chamber to maintain a constant pressure based on the pressure measurement from sensor P1. As the temperature within the N₂O₄ increases to generate additional NO₂ in the headspace, the piston can be retracted to respond to the next transient event. The piston motion is moved by a piston driver (e.g. linear motor, solenoid, ball-screw mechanism, crank-rocker, cam, etc.) which is controlled by the device controller. It should be understood that other mechanisms for achieving a change in reservoir volume are also included in the scope of this invention (e.g., solenoid-driven diaphragm, piezo-actuated diaphragm, etc.).

In some embodiments, the flow controller is a fixed orifice. The flow rate through a fixed orifice depends on the pressure gradient across the orifice. By adjusting the pressure in the NO₂ gas, a range of flow gas flow rate through the orifice are possible.

In some embodiments, the flow controller is an actively-controlled flow controller (e.g., needle and seat valve, ball valve, gate valve, array of fixed orifices with binary valves, etc.). In some embodiments the flow control is binary. Binary flow control is sufficient for treatments receiving a constant level of NO flow or pulsatile NO flow where the flow control is simply on or off. In some embodiments, the flow can be modulated. In some embodiments of NO flow modulation, NO flow is delivered at a flow rate that is proportional to the inspiratory gas flow. As mentioned previously, the inspiratory flow rate can be measured directly by one or more flow sensors or received from an external device (e.g. a ventilator). Control of NO flow can be accomplished with a myriad of flow control devices and combinations of flow control devices including pumps, binary valves, proportional valves, and the like. In some embodiments, more than one flow control element is utilized to improve the flow accuracy across a range of flow rates (e.g. a low range flow controller combined with a high range flow controller). In some embodiments, more than one flow control element is utilized to provide redundancy and continuous delivery of NO in the event of a flow control element failure (i.e. use or two or more identical flow controllers).

The system shown in FIG. 11 can include a removable N₂O₄ container 218. In some embodiments, the container 218 consists of a volume of N₂O₄ liquid with a 1-way valve 224 at the end. The container is inserted into a container socket 220 in the NO generator that interfaces with the 1-way valve. In the embodiment shown, a tube 222 inserts through the valve to enable NO₂ to leave the container and enter a NO₂ chamber. In some embodiments, the container is held in place by friction between the container seal and the tube. In some embodiments, the container is threaded into the socket and the threads retain the container. In some embodiments, a mechanical retention feature in the socket holds the container in place and includes a release feature that is operated by the user (e.g., release button, door that closes behind the container and holds it in place, etc.). Heat is applied to the socket by a heater and NO₂ exits the N₂O₄ container through the valve. When the container is removed, the valve seals again, retaining N₂O₄ within the container.

In some embodiments, a N₂O₄ container is packaged in a cartridge that includes a memory device that includes information that can be read by the NO delivery device. Exemplary information includes but is not limited to whether or not the cartridge has been inserted into a system before, the manufacturing date, the manufacturer, the expiration date, and the container size. In some embodiments, cartridges are designed and sized for particular patient applications, patient types, NO concentration range, NO production levels and flow rate ranges.

It should be understood that the system depicted in FIG. 11 releases NO₂ into a gas stream. Conversion of the NO₂ gas stream into an NO gas stream can be accomplished in various ways, as listed above.

The quantity of N₂O₄ in a container is finite. Hence, there can be a benefit to prolonging the service life of an N₂O₄ container (or other NO₂ source for that matter) when NO is delivered to a patient in a pulsatile manner only at times where it is needed. When NO is typically administered to a ventilator circuit, for example, a NO delivery system doses all of the gas flowing through the inspiratory limb even though only a subset of that gas is actually inhaled by a patient. When NO is delivered to a patient as a pulse, timed with an inspiratory event, significant savings in NO and/or the NO source can be had.

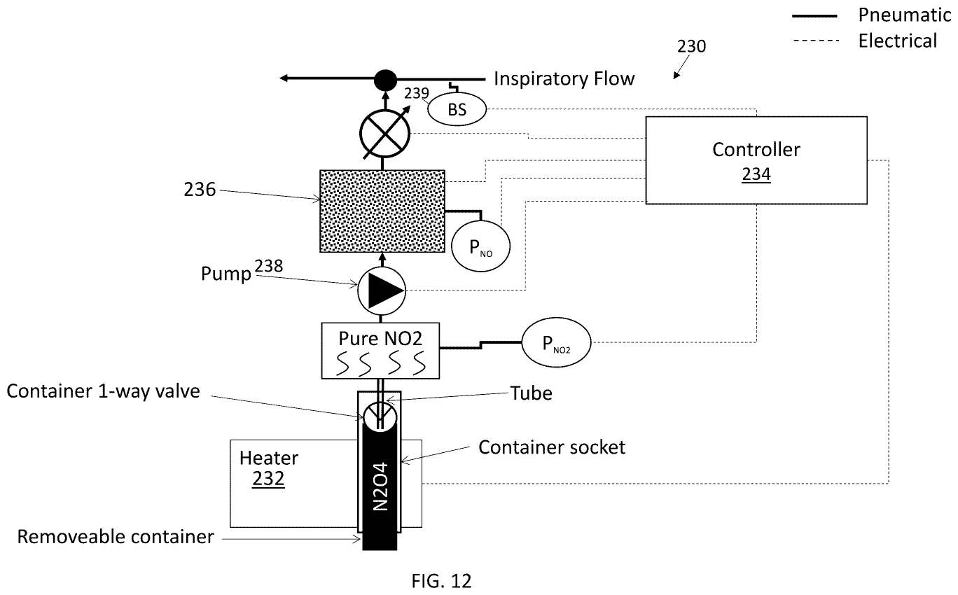

FIG. 12 depicts an exemplary embodiment of a system 230 that generates a NO gas flow, sourcing NO₂ from a container of N₂O₄. In some embodiments, N₂O₄ is heated with a heater 232 to form NO₂ gas. A controller 234 can be configured to modulate the heater 232 to maintain NO₂ pressure within the headspace based on feedback from either a pressure sensor (shown) or a temperature sensor (not shown).

The NO₂ gas accumulates in either an NO₂ reservoir (shown) or headspace within the N₂O₄ reservoir and is propelled by a pump into a conversion and storage reservoir. In some embodiments, the NO₂ storage volume is specified to provide sufficient NO₂ gas during peak gas demand. In some embodiments, the conversion and storage reservoir 236 can include (i.e., is at least partially filled with) a material that reduces the NO₂ into NO (e.g., ascorbic acid). In some embodiments, NO₂ is converted to NO within the storage reservoir 236 using one or more of the methods identified herein (e.g., chemical, heat, catalyst, etc.). In some embodiments, the size of the conversion and storage reservoir is determined by one or more of the peak NO flow rate that may be delivered to the inspiratory flow, a minimum pressure permissible in the reservoir, NO flow controller pressure range, and the amount of residence time required for the conversion process to complete. In some embodiments, the controller 234 operates a pump 238 and the N₂O₄ heater 232 to keep up with demand for NO. In some embodiments, the controller utilizes the indicated pressure within the conversion and storage reservoir in determining the degree to open an output valve from the conversion and storage reservoir to deliver NO into an inspiratory flow or directly to a patient (e.g. nasal cannula). In some embodiments, the rate of change in pressure within the conversion and storage reservoir is utilized by the controller as an indicator of flow rate exiting the conversion and storage reservoir. A breath sensor 239 (e.g., flow, temperature, optical, mass flow, pressure) monitors a gas flow. The controller 234 utilizes the breath sensor 239 to determine when to add NO to a gas flow (e.g. inspiratory flow). In some embodiments, NO is released from the gas storage in pulses, coinciding with a breath event (e.g. inspiration). In some embodiments, NO is released continuously. In some embodiment, NO is released in proportion to the flow rate measured within the gas flow.

In some embodiments, the pump operates continuously. In some embodiments, the gas storage and scrubber reservoir include a pressure release mechanism to prevent over pressurization. In some embodiments, gas released through a pressure release mechanism is scrubbed for one or more of NO and NO₂ prior to release into the atmosphere.

In some embodiments, NO₂ gas entering the reservoir is diluted with another gas (e.g. N₂, air). This can reduce the concentration of the NO formed, facilitating NO flow control. In some embodiments (not shown), oxygen concentration technology (e.g. pressure swing adsorption) is utilized to reduce the oxygen level in one or more of a dilution or a purge gas to decrease the rate of NO₂ formation from NO oxidation.

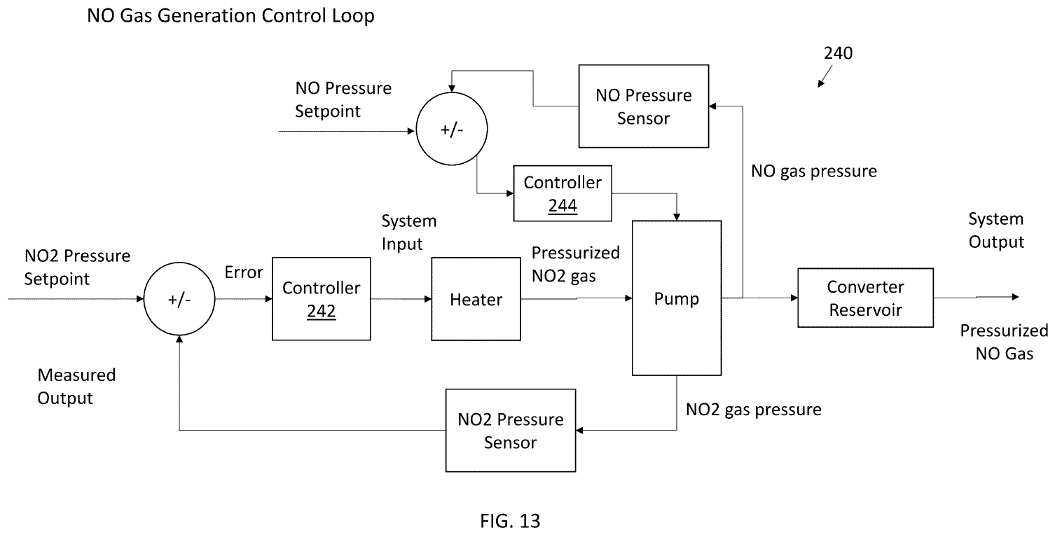

FIG. 13 depicts an exemplary control scheme 240 for the system shown in FIG. 12. A controller 242 can be used to vary the heater to produce pressured NO₂ at the target set point. An additional controller 244 can be used to vary the pump activity to maintain a target NO pressure within the conversion and storage reservoir. The output of the control system is pressured NO within the conversion and storage reservoir. It will be understood that the functionality of the first and second controllers 242, 244 can be performed by a single controller or processor.

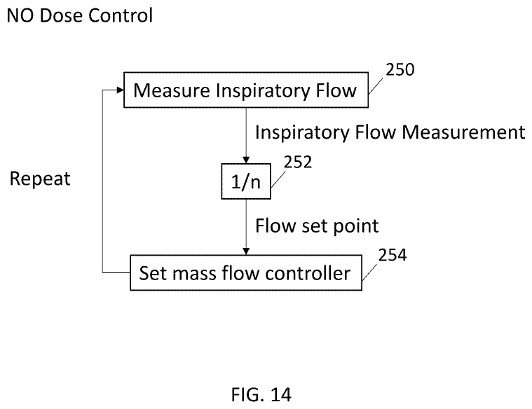

FIG. 14 depicts an exemplary embodiment of a flowchart showing a feedforward control scheme for delivering NO to an inspiratory flow. The inspiratory flow is measured (step 250). The inspiratory flow value is multiplied by a dilution ratio (step 252) to determine a target NO mass flow. The NO injection flow controller is then set to the target NO mass flow value (step 254).

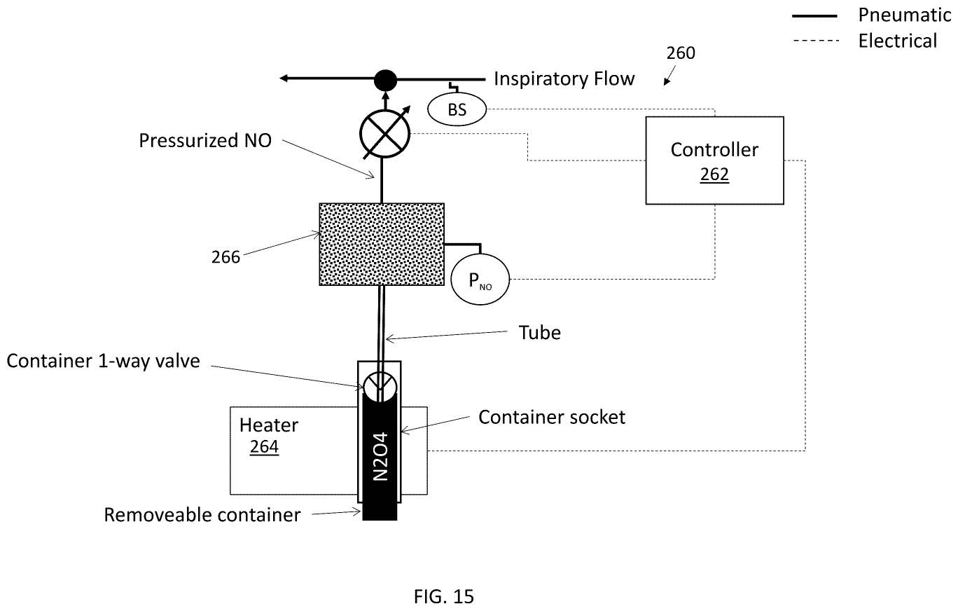

FIG. 15 depicts an embodiment of a NO delivery system 260 that sources NO from N₂O₄. A device controller 262 modulates a heater 264 that heats the N₂O₄ to form NO₂ gas. NO₂ gas enters a conversion and/or storage reservoir 266 filled with a reducing material (e.g., ascorbic acid, TEMPO, etc.) that converts the NO₂ into NO. Pressure within the storage reservoir increased with heating of N₂O₄ and decreased when NO gas is released from the system.

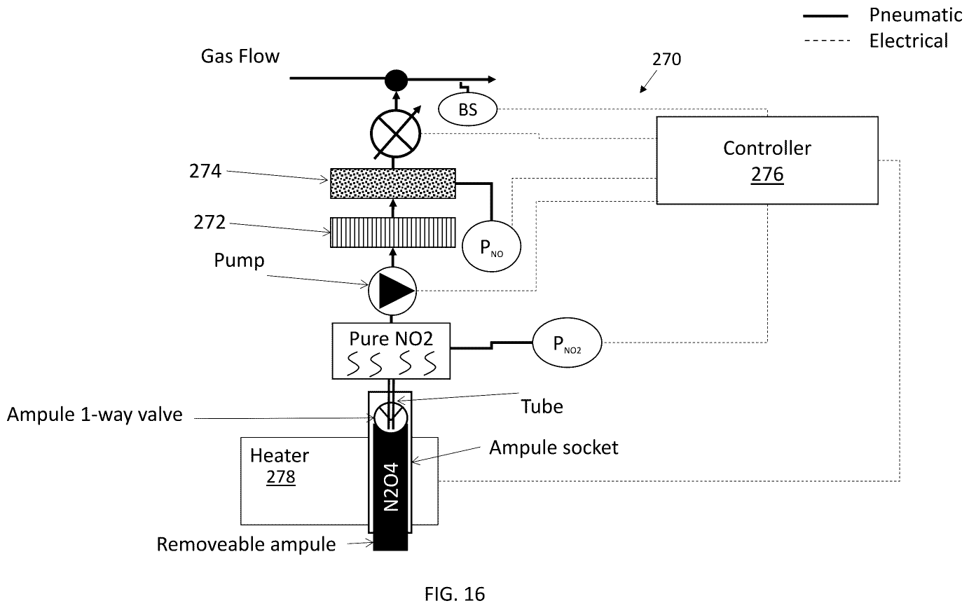

FIG. 16 depicts an exemplary embodiment of a system 270 that converts NO₂ to NO within a converter 272. A device controller 276 modulates a heater 278 that heats N₂O₄ to form NO₂ gas, which flows to the converter 272. NO gas then flows from the converter to a reservoir 274 where it accumulates, increasing the pressure within the reservoir. In some embodiments, the reservoir is at least partially filled with one or more of a NO₂ scrubbing material or a NO₂ reducing material.

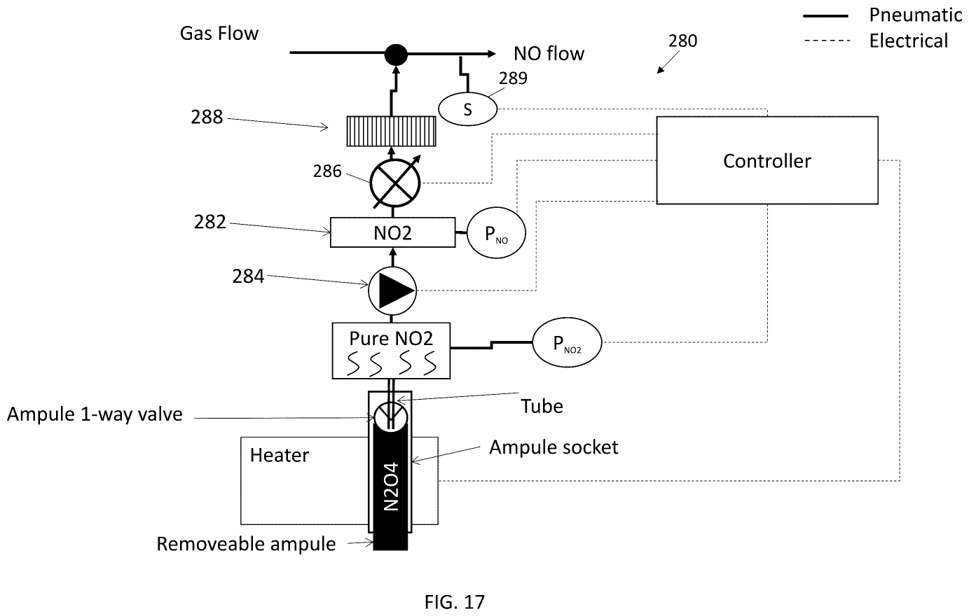

FIG. 17 depicts an exemplary embodiment of a system 280 that forms NO₂ from N₂O₄. The NO₂ is transferred from the N₂O₄ chamber to a separate chamber or storage reservoir 282 by a pump 284 where it accumulates, gaining pressure. The NO₂ is released from the pressurized chamber by a flow controller 286 (e.g., a mass flow controller). The flow of NO₂ from the system passes through a converter 288 that converts NO₂ to NO and is then delivered to an external flow (e.g. inspiratory flow, airway flow, etc.). A sensor 289 monitors the external flow to inform the system controller about the timing and volume of NO to delivery. In some embodiments, NO is delivered in a pulsatile manner. In some embodiments, NO is delivered continuously. In some embodiments, NO is delivered in proportion to the indicated flow rate in the external flow.

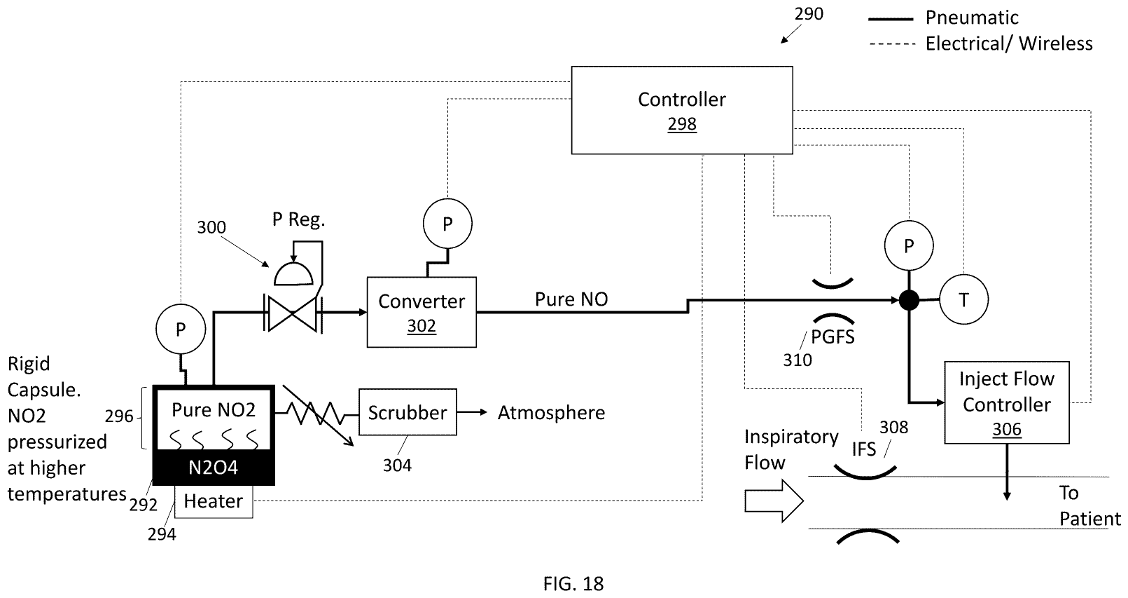

FIG. 18 depicts an exemplary embodiment of a system 290 that includes a N₂O₄ reservoir or chamber 292 that is actively heated with a heater 294. The N₂O₄ chamber includes a headspace 296 for NO₂ gas. A controller 298 receives information regarding measurements of a pressure and/or temperature level within the chamber and modulates the output of the heater to maintain sufficient NO₂ gas within the headspace 296. Typically, the controller 298 modulates the power to the heater to maintain a pressure within the headspace to exceed a minimum threshold. A pressure regulator 300 at the outlet of the headspace releases NO₂ gas from the headspace to a converter 302 that converts NO₂ to NO gas. A pressure relief valve, typically set at a higher pressure than the pressure regulator, protects the system from over pressurization. In some embodiments, as shown, NO₂ gas released by the pressure relief valve passes through a NO₂ scrubber 304 prior to release into the atmosphere. In some embodiments, if the NO gas exiting the NO₂ converter is not sufficiently pure, the NO gas is passed through an NO₂ scrubber (not shown) to remove some or all of the NO₂ from the gas stream. In some embodiments, the NO₂ gas is mixed with air (not shown) prior to scrubbing with an NO₂ scrubber (e.g., soda lime) prior to release from the system. In some embodiments, the NO₂ scrubber consists of one or more of soda lime, potassium permanganate, activated carbon, a metal hydroxide, a water bath, a metal organic framework material, TEMPO, or other material known to remove NO₂ from a gas stream. Use of an NO₂ scrubber downstream of the NO₂ reducer component can serve as a safety measure in the case that the NO₂ reducer fails or becomes exhausted.

In some embodiments, as shown, pure NO gas exits the converter and is injected through a flow controller into an inspiratory stream. A pressure sensor and optional temperature sensor upstream of the flow controller are utilized to calculate flow controller settings to ensure accurate NO delivery. In some embodiments, the pressure measurement is also used to confirm proper function of the pressure regulator. In some embodiments, the controller controls the injection flow controller 306 to introduce NO at a rate that is proportional to the inspiratory flow rate, as measured by an inline flow sensor (IFS) 308. Flow rate of the injected NO gas is measured by a product gas flow sensor (PGFS) 310 that can be located before (shown) or after (not shown) the injection flow controller. When operating with pure NO, the quantity of gas to be delivered to an inspiratory gas stream can be extremely small, requiring microfluidics to manage the miniscule NO gas flow. In an exemplary embodiment, a NO generation and delivery system targets 20 ppm NO in the inspiratory stream. The controller measures the inspiratory mass flow rate to be 10 slpm. The controller utilizes gas sensors to quantify the gas constituents (e.g., oxygen, nitrogen, helium) and additional sensors to measure gas conditions (e.g., temperature, pressure, humidity). Then, the controller calculates one or more of a density and molar mass of the inspiratory gas. Inspiratory mass flow can be calculated as:

Inspiratory Flow (slpm)*Std gas density (g/liter)=Inspiratory mass flow (g/min)

The molar mass flow is calculated as:

$$\frac{Inspiratory mass flow ( g / min )}{molar mass ( g / mol )} = Inspiratory molar mass flow ( Mole / min )$$

Given that moles refer to individual molecules, the quantity of NO molecules required (20 ppm in this example) is applied. Target NO molar mass flow rate can be calculated as:

Inspiratory mass flow rate (mole/min)*20/1E6=Target NO molar mass flow rate

Then the target NO molar mass flow rate can be converted to NO mass flow rate: NO molar mass flow rate (Mole/min)*NO molar mass (30.006 g/mole)=NO mass flow (g/min)

Using the NO density under standard conditions, the NO volumetric flow is derived as:

$$\frac{NO mass flow ( g / min )}{NO std . density ( 1.3402 g / liter )} = NO volumetric flow ( liter / min )$$

For this example, the NO flow required would be 3 μl/sec to dose a 10 lpm flow of air to 20 ppm NO. The controller utilizes a mass flow controller to release NO at the target flow rate. The mass flow controller calculates a density of the NO gas based on the temperature and pressure of the NO gas and opens an orifice a specific amount to release the desired amount of gas. In embodiments that dilute the NO gas prior to injection into an inspiratory flow (not shown), a NO concentration sensor can be utilized as an input to the injection calculation to determine the correct mass flow rate of product gas to achieve a target number of moles of NO delivered.

Given that management of 100% NO can be a challenge from a flow control (microfluidic methods required) and materials compatibility standpoint, some embodiments dilute either the NO₂ gas, the NO gas exiting the converter, or both to decrease the NO concentration and to work within flow rate ranges that are more easily managed with conventional flow control hardware. Dilution of NO₂ with air is less technically complex because NO₂ is relatively stable in air and will not oxidize further. Ideally, dilution of NO is done with an inert gas (e.g., N₂, Ar, CO2), however dilution with air can be acceptable for short periods of time (seconds). When NO is diluted by an inert gas, the inert gas is either sourced from an external source (e.g., compressed cylinder) or generated by the device (e.g., nitrogen separation via membrane or pressure swing adsorption).

There are various approaches to dilution of gas within the system. In some embodiments, the dilution ratio of NO or NO₂ is constant, resulting in a constant diluted concentration of NO or NO₂, respectively. In one embodiment, the controller accomplishes a constant diluted concentration by measuring the flow of NO or NO₂ and dilution gas and modulating respective flow controllers to achieve a constant concentration. In another embodiment, the controller utilizes a NO or NO₂ sensor (as appropriate) to measure the concentration of the diluted gas and will vary the level of dilution via a flow controller as needed to maintain a target concentration of NO or NO₂ gas. Maintaining a constant concentration of NO or NO₂ can facilitate dosing of an inspiratory flow because the controller only needs to measure the inspiratory flow rate and deliver a proportional flow rate of NO. In one example, the rate of NO₂ production from a heated container of N₂O₄ will vary with the temperature of N₂O₄. By varying the dilution flow rate via a dilution flow controller (e.g. valve), the controller can make the dilution flow rate scale to the NO₂ production rate so that that diluted gas concentration remains constant.

In some embodiments, one or both of the NO or NO₂ flow and the dilution gas flow is constant and the other flow varies. In some embodiments, the flow of NO₂ and dilution gas are adjusted to achieve a consistent combined flow rate. In some embodiments, the flow of NO and dilution gas are adjusted simultaneously to achieve a consistent combined flow rate. This approach results in a varying dilution ratio between the NOx gas (NO or NO₂) and dilution gas and variable concentration of NO gas for injection. In some embodiments, the controller measures the actual concentration of NO, pre-injection and varies the flow rate of NO delivery as needed to achieve a target molar delivery rate. While variable concentration NO presents some additional complexity, it may be necessary when the NO or NO₂ source has a variable production rate.

In some embodiments, a consistent dilution ratio is utilized resulting in consistent concentration of NO or NO₂. In some embodiments, the system utilizes more than one dilution ratio for a gas (NO or NO₂) depending on the overall production level required. For example, NO or NO₂ gas may be diluted 10:1 for high production levels or 100:1 for low production levels. The additional degree of freedom of varying gas concentration enables the system to work with a more narrow range of flow rates to address all clinical scenarios. A narrower range of flow rates enables the use of simpler flow control devices and helps improve flow accuracy. In some embodiments, the dilution ratio is held constant for given patient treatment parameters (e.g., tidal volume, target NO, respiratory rate, minute volume) and in other embodiments, the dilution ratio varies.

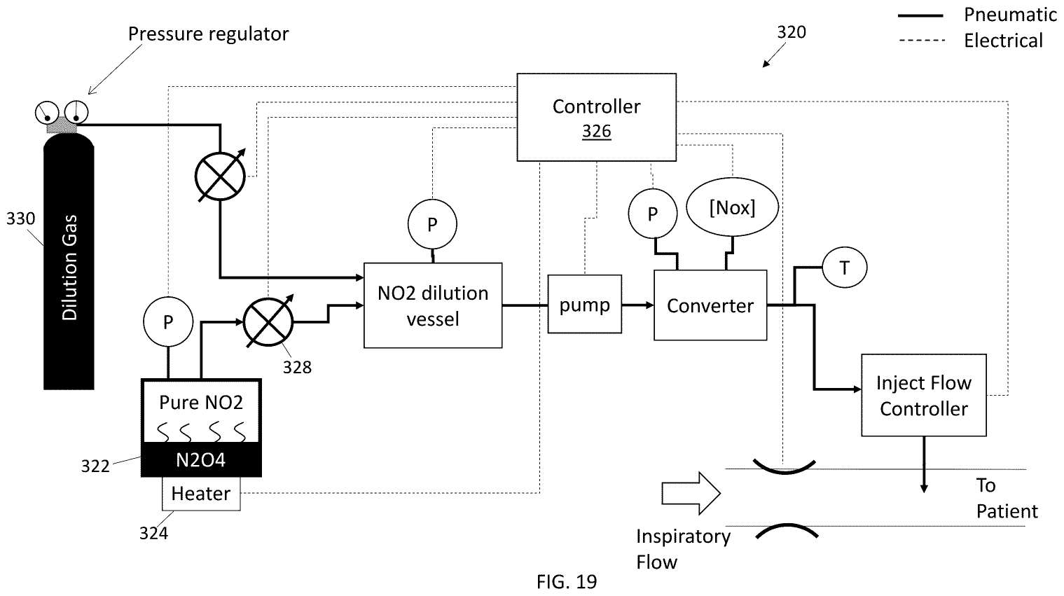

FIG. 19 depicts an exemplary embodiment of a NO delivery system 320 that creates NO from N₂O₄ stored in a reservoir 322. The reservoir is actively heated with a heater 324 to maintain one or more of a minimum pressure or a minimum temperature within the reservoir. The pressure within the reservoir is the vapor pressure of N₂O₄. The relationship between vapor pressure and temperature is such that as the temperature increase, the vapor pressure will also increase. In some embodiments, the heat applied to the N₂O₄ reservoir is controlled by the controller 326 to target a specific gas pressure, temperature or both within the reservoir based on pressure (shown) and temperature (not shown) sensor measurements, respectively. In some embodiments, the controller utilizes a proportional integral derivative (PID) control scheme to modulate the heater in the N₂O₄ reservoir to maintain a target pressure or temperature within the reservoir based on a sensor measurement input. In some embodiments, a minimum target pressure is targeted, the pressure being sufficient to drive the flow of NO₂ gas to downstream components. In some embodiments, the range of target NO₂ gas source pressure is in the range of 1 to 25 psi. In some embodiments, a higher NO₂ gas pressure is desired. In some embodiments, a pressure regulator (not shown) between the reservoir and NO₂ flow controller reduces the N₂O₄ reservoir gas pressure to a constant level to provide consistent inputs to the NO₂ flow controller.

A flow controller 328 (e.g. mass flow controller), controlled by the system controller, meters out NO₂ gas at a desired mass flow rate based on the pressure within the N₂O₄ reservoir. The NO₂ gas is diluted with another gas sourced from a dilution gas source 330, such as a compressed cylinder. Dilution gas pressure within the cylinder is reduced by a pressure regulator and flow is controlled by a flow controller. Dilution gas and NO₂ gas are introduced to an optional dilution vessel. The gas mixture is removed from the dilution vessel by a pump. In some embodiments, the system does not include the dilution gas flow controller since the dilution gas source will make up the difference between the amount of NO₂ introduced to the flow and the amount of flow required by the pump.

In some embodiments, the controller captures one or more parameters about the dilution gas including humidity, temperature, pressure and flow rate using one or more sensors.

Dilution gas (e.g., air) can be sourced from one or more of the environment, a cylinder, or a house gas supply (i.e., compressor). When gas is sourced from the environment, various levels of conditioning of the air may be necessary. For example, particle filtration, VOC scrubbing and humidity management are common treatments for incoming air. In some embodiments, air preparation is actively controlled by the controller. For example, the level of humidity removal can be actively controlled based on the humidity level in the incoming air, as measured by a humidity sensor. In some embodiments, a clogged particle filter can be detected by the controller based on the pressure within the air preparation stage or dilution vessel. The degree of humidity removal in a dilution gas can be based on one or more of the following: the maximum humidity allowable without condensing within the system (a function of pressure within the system), a particular range required by gas-contacting sensors within the system, and a particular range required by a converter or scrubber in the system.

Pressure, temperature and flow rate information provided to the controller enable the controller to calculate the actual molar flow rate (n/dt) of the dilution gas using the first derivative of the ideal gas law with respect to time:

P*V/dt=n/dt*RT

where, P is the absolute pressure, V/dt=the volumetric flow rate, n/dt is the molar flow rate, R is the ideal gas constant and T is the absolute temperature.

Solving for n/dt, n/dt=(P*V/dt)/(RT). Absolute pressure (P) is measured by a gas pressure sensor. V/dt is measured by a flow sensor. R is the ideal gas constant and T is the absolute temperature, as measured by a temperature sensor.

Diluted gas passes through the pump, which can be any type of fluid pump, including but not limited to diaphragm, screw, gear, peristaltic, piezo and others. Then, the gas passes through a converter (e.g., a reducer (e.g., ascorbic acid), a catalyst (e.g., heated Mb), a UV light source, a heater, etc.) that converts NO₂ to NO. One or more of NO concentration, pressure and temperature of the gas within the converter (or in fluid communication with the converter) is measured and delivered to the device controller which uses that information to provide input to the injection flow controller. In the event that NO concentration, pressure and/or temperature are out of an expected range, the system generates an alarm. Pressure can be too low when the NO₂ and/or dilution gas supply have been exhausted, or if there is a failure or blockage in the pneumatic system. Out of range temperature measurements are indicative of use of the device out of expected ambient temperature range or failure of a temperature sensor. In some embodiments, the concentration of the NO and/or NO₂ is also measured. In some embodiments, NO concentration is measured before injection (shown) and/or after injection in the dosed inspiratory gas (not shown).

In some embodiments, the injection flow controller is controlled by the controller to deliver specific mass flow rates of NO to an inspiratory flow. The degree to which a flow controller must open to deliver a specific mass flow can be related to the pressure of NO gas, temperature of NO gas, and concentration of NO gas. The relationship between these variables is typically characterized during development and stored within the controller as either a mathematical function or look-up-table. In practice, the controller measures the inspiratory flow to be dosed and then opens the injection flow controller to the specific degree that will deliver a specific flow of NO that will accurately dose the inspiratory flow. In some embodiments, the injection controller is modulated to provide a mass flow rate of NO proportional to the inspiratory flow. In some embodiments, the injection flow controller is controlled by the system controller based on input from one or more of an inspiratory flow sensor, upstream gas pressure sensor (within the converter in this case), an upstream NO sensor, an upstream NO₂ sensor, a humidity sensor, a temperature sensor, and a target NO dose level. In some embodiments, the injection controller is utilized to deliver pulses of NO gas (i.e., boluses) as required for the dosing strategy.

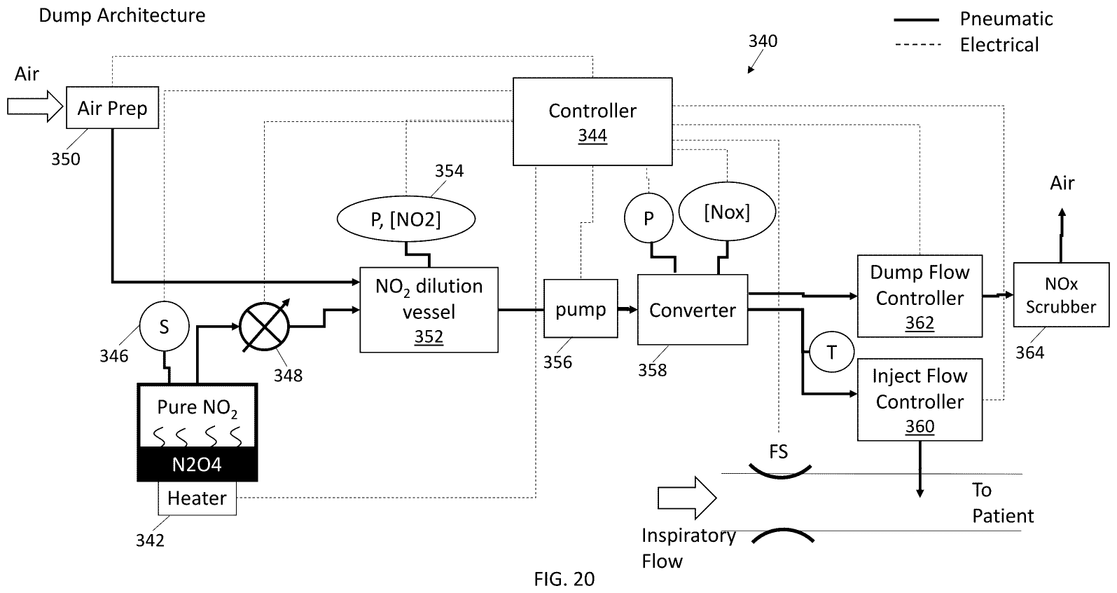

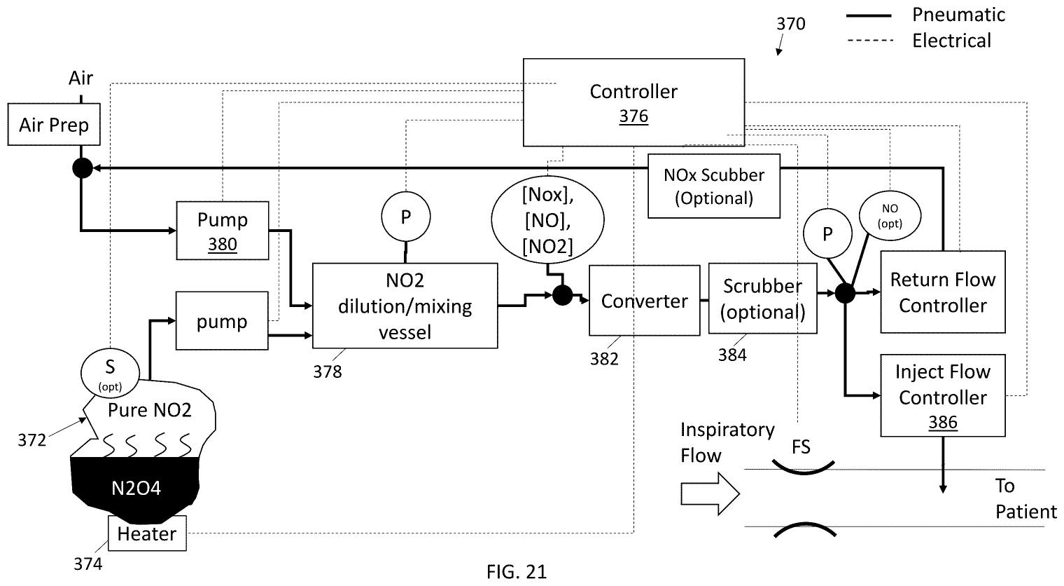

FIG. 20 depicts an exemplary embodiment of a system 340 that sources NO from N₂O₄ and delivers NO proportionally with inspiratory flow to achieve constant inhaled NO concentration at a patient. A heater 342 is actively controlled by the treatment controller 344, in communication with a sensor 346, to maintain one or more of a target temperature and a target pressure within the N₂O₄ chamber. A flow controller 348, also controlled by the controller, governs the flow of NO₂ gas into a dilution stream of air. The air is sourced from the environment and passes through an air preparation stage 350 that is optionally controlled by the controller. Air and NO₂ gases meet in a dilution chamber 352 where pressure (P) and NO₂ concentration ([NO₂]) are optionally measured using one or more sensors 354. Gas is removed from the dilution chamber by a pump 356. In some embodiments, the pump 356 operates at a constant flow rate to simplify downstream operations. In some embodiments (as shown), air flow entering the system is passive, meaning that there is no active pumping on the dilution gas alone. Air flow makes up for the difference between flows between the pump and NO₂ flow controller. Passive dilution gas flow allows for reduced complexity and reduced acoustic noise generation.

The pump 356 delivers the NO₂/air mixture to a converter 358 that converts the NO₂ to NO. In some embodiments, the pump operation is continuous. In some embodiments (not shown), a NO₂ scrubber is utilized after the converter to remove any remaining NO₂ from the gas stream. A portion of the flow of gas exiting the converter 358 passes through a flow controller 360 that delivers a specific mass flow rate of NO in proportion to the inspiratory flow rate. The balance of NO gas flow exiting the converter passes through a dump flow controller 362 and a NOx scrubber 364 prior to venting to the atmosphere. An optional NOx sensor measures the concentration of NO exiting the NOx scrubber. In some embodiments, the dump flow controller and the NOx scrubber design are utilized when one or more of the timing, pressure, temperature, and concentrations within the system are not understood well enough that the controller can predict via computation or measurement, the NO concentration at the NO injector. The dump flow path enables a NO generation system to operate at a constant NO production level (flow rate*concentration) so that the concentration at the injector can be known via one or more of calculation, system calibration to characterize NO losses as a function of flow rate and NO concentration, and direct measurement. The dump flow path enables NO of a known age to be at the injector at all times with excess NO being destroyed. Pressure (shown), temperature (not shown) and humidity (not shown) measurements of the gas exiting the converter and/or NO₂ scrubber can inform the controller for more accurate operation of the purge and injection flow controllers.

In some embodiments, the pump operates to generate a constant flow rate to supply gas to the injection and dump flow controllers. The dump flow controller operates, as directed by the system controller, to maintain a constant pressure upstream. This provides constant inputs of NO concentration and pressure for the injection flow controller for improved accuracy.

FIG. 21 depicts an exemplary NO generation and delivery system 370 that decouples NO generation from NO delivery. In the illustrated embodiment, NO₂ is generated by heating a container 372 of N₂O₄ using a heater 374. In some embodiments, the container 372 is rigid (not shown). In some embodiments, the N₂O₄ container 372 is soft-walled (shown) to accommodate changes in gas volume without related pressure increases. In some embodiments, the soft walled container is an expansion chamber with a diaphragm or piston that moves to accommodate varying amounts of gas (not shown). In some embodiments, the wall of the container is elastomeric (stretchy). In some embodiments, the wall of the container does not stretch but the volume of the container is large in comparison to the volume of gas within, so that the gas is always at or near atmospheric pressure. In the illustrated embodiment, as N₂O₄ turns into NO₂, the volume of the NO₂ container increases while remaining at atmospheric pressure. An optional strain sensor labeled “S” in the figure measures the strain in the wall of the reservoir as an indication of the volume of NO₂ gas available. In some embodiments, the volume of the reservoir is measured optically by measuring the displacement of the chamber. In some embodiments, the volume is measured optically with a fringe pattern indicative of wall strain.

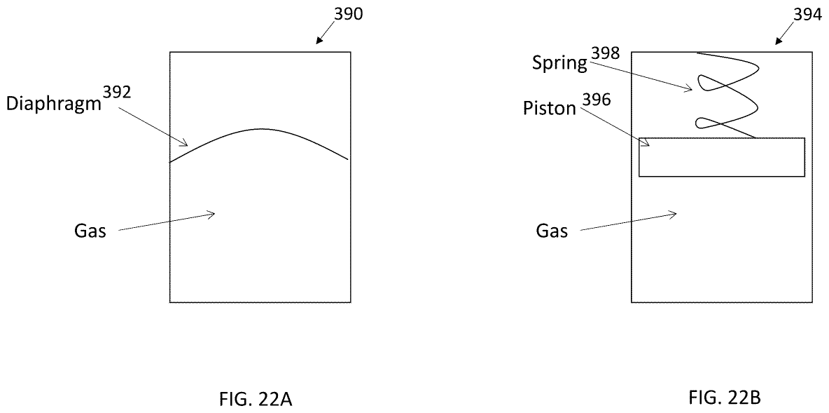

In some embodiments, the heater 374 is an electrical resistance heater. The heater 374 is controlled by a device controller 376. When a rigid container is utilized, pressure or temperature within the N₂O₄ chamber is utilized as feedback to the heating circuit. In one embodiment of a soft-walled container, strain in the wall of the vessel and/or pressure are measured by a sensor and utilized by the controller for heating circuit feedback. Pure NO₂ gas within the NO₂ chamber is removed from the chamber via a pump. The pump is calibrated to deliver known amounts of NO₂ to a dilution vessel. In some embodiments, the pressure within the NO₂ reservoir is utilized by the system controller to improve the pump flow accuracy. Use of a soft-walled gas chamber or expansion chamber enables a system to accommodate excess or deficient gas due to heating inaccuracies (e.g., temperature overshoot) and time delays in heating the N₂O₄ source material. FIG. 22A depicts an exemplary expansion chamber 390 that uses a diaphragm 392 to accommodate varying amounts of gas. FIG. 22B depicts an exemplary expansion chamber 394 that utilizes a piston 396 and spring 398.

In some embodiments, a mass flow controller and/or sensor after the NO₂ pump (not shown) measures the actual quantity of NO₂ introduced to the dilution vessel 378. In some embodiments, the mass flow rate through the pump is calibrated to account for the delta pressure between the N₂O₄ chamber and the dilution vessel. In some embodiments that utilize a rigid N₂O₄ chamber, temperature within the N₂O₄ chamber is modulated to obtain gas pressure within a target range. In some embodiments, the system operates with vacuum pressure (e.g. <0 psig) to lower the boiling point of N₂O₄ within the N₂O₄ chamber. This approach promotes the conversion of N₂O₄ to NO₂ without the energy intensive process of heating the chamber.

A dilution gas (e.g., air, nitrogen, etc.) flow can enter the system, drawn by a pump 380. When environmental air is sourced, various levels of air preparation may be necessary to prevent condensation within the system due to pressure and ensure dose accuracy. The air preparation stage can involve one or more of particle filtering, humidity management, VOC scrubbing, and NOx scrubbing. In some embodiments (not shown), oxygen separation technology (e.g., pressure swing adsorption with molecular sieve material) is used to separate oxygen from air so that the remaining nitrogen can be used as a dilution gas.

After conditioning the dilution gas, the gas is introduced to the dilution chamber 378. In some embodiments, the air pump is calibrated to deliver a known mass flow rate of dilution gas. In other embodiments, a mass flow sensor (not shown) measures the actual gas flow and is used by the controller to control the pump in a closed-loop fashion.

The dilution vessel 378 contains a mixture of pure NO₂ gas from the N₂O₄ reservoir, dilution gas, and return gas (to be described later). In some embodiments, this mixture of gas is mixed by one or more of static mixing, active mixing (e.g., rotating fan blade), or directing the incoming flows to intersect and blend (not shown). Pressure within the dilution vessel is measured by a pressure sensor and utilized in some instances by the controller to vary the incoming flows to the dilution vessel. Using a dilution vessel allows for the concentration of NO₂ to be reduced to a manageable level that facilitates flow management in a range compatible with currently-available flow controllers. Without dilution, the system would be controlling the flow of 100% NO₂ and 100% NO which would involve controlling the flow of nanoliters of gas volume.

Gas within the dilution vessel is stable over time since it is only NO₂ and air. A NOx or NO₂ sensor in fluid communication with the reservoir can be utilized by the controller to confirm that NO₂ is present and quantify the concentration of NO₂ in the product gas.

In some embodiments, gas within the dilution vessel exits the system towards a region of lower pressure. In some embodiments, gas within the dilution vessel is pumped out with an additional pump (not shown) to elevate the pressure within the diluted gas. The diluted NO₂ gas passes through a converter 382 that converts NO₂ into NO gas. In some embodiments, ascorbic acid is utilized to convert NO₂ into NO, however other chemistries have been contemplated.

In some embodiments, NO gas exiting the converter passes through an optional NO₂ scrubber 384 to remove any remaining NO₂ from the gas stream. After the converter and NO₂ scrubber, the gas flow reaches a bifurcation in the flow path. A portion of the flow passes through an injection flow controller 386 that introduces controlled amounts of NO to an inspiratory flow. In some embodiments, the injected NO flow is proportional to the inspiratory flow (e.g. to achieve a target concentration within the inspiratory flow). In some embodiments, the injected NO is delivered as a bolus (e.g. finite number of NO molecules) at specific times within the inspiratory cycle. A pressure sensor and optional NO sensor upstream of the injection flow controller informs the controller of gas conditions at the injector. NO concentration can be increased by introducing more NO₂ gas into the system. Pressure is varied by modulating the return path flow controller in the recirculation loop.

Gas flow through the recirculation loop is continuous. This ensures that NO gas is freshly scrubbed and ready for injection at all times. Gas that does not pass through the injection flow controller passes through another flow controller (i.e., the return flow controller) to enter a return pathway (i.e., a recirculation loop). The return pathway introduces NO/NO₂ gas to the incoming air pathway. This preserves NO/NO₂ to prolong the service life of a N₂O₄ reservoir. This approach also eliminates the need to release NO/NO₂ to the environment which requires NOx scrubbing. In other words, gas that is not injected to the patient is returned to the system where additional NO is generated to make-up for injected NO. In some embodiments, NO generation is modulated by the controller to maintain a constant concentration of NO₂/NO within the loop. In some embodiments, pump speeds are modulated by the controller to maintain a constant flow rate through the converter, NO₂ scrubber and to the injector. The NO injector utilizes the constant concentration and pressure of NO at its inlet to accurately inject the required amount of NO into the inspiratory stream. Since not all of the NO that is generated is delivered to the patient, the system has effectively decoupled NO production and NO delivery to the patient.

An optional pressure sensor in fluid communication with one or more of the converter and the NO₂ scrubber measures the pressure of the gas to account for any changes due to flow restriction within the converter and NO₂ scrubber. The pressure sensor is utilized by the system controller to modulate the return flow controller to maintain a known (typically constant) NO gas pressure.

By returning a portion of the NO/NO₂ to the incoming air stream, the concentration within the converter can vary. A NOx sensor in fluid communication with the gas pathway enables the system to track the amount of NO/NO₂ within the system. When the patient demand for NO is low, the controller can modulate the NO₂ flow from the N₂O₄ reservoir to preserve N₂O₄. In some embodiments, the concentration of NO₂ within the dilution vessel is lower for patient treatments that require low amounts of NO and higher for treatments that require high amounts of NO. In some embodiments, the NOx sensor information also serves as an input to calculating the mass flow rate of NO gas through the injector to achieve a target concentration.

In some embodiments, an optional NOx scrubber within the return path is utilized to keep the system closed while simplifying the controls.

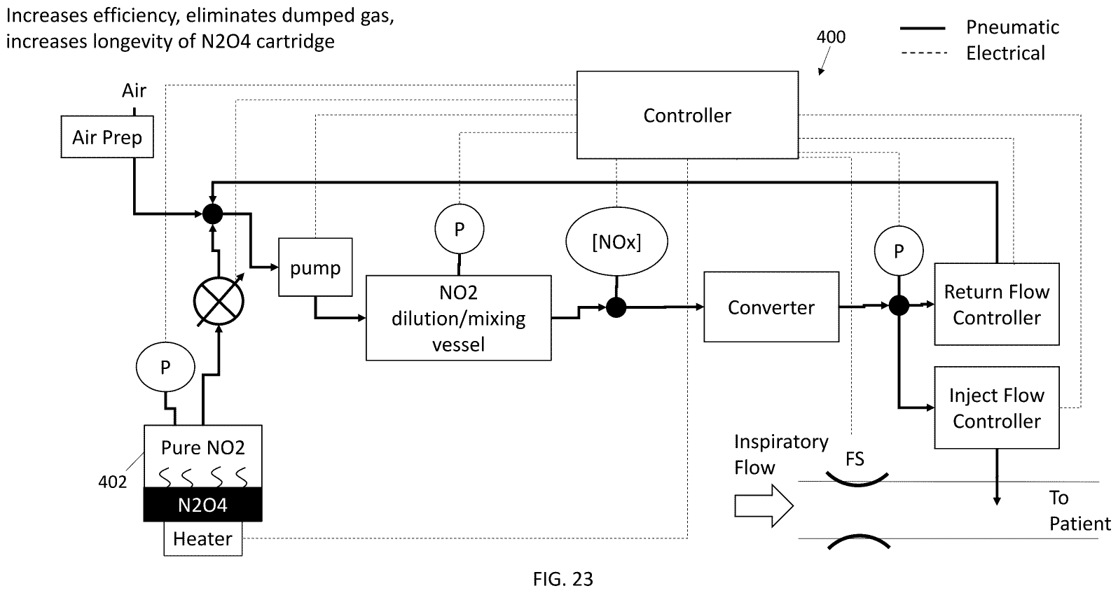

FIG. 23 depicts another exemplary embodiment of a system 400 that utilizes a N₂O₄ container or vessel 402. The controller manages the heater to maintain a minimum volume of NO₂ at all times. NO₂ gas and dilution gas flow into a flow divider (e.g., blender, one or more flow controllers) that can vary the mixture of dilution gas and NO₂ gas to achieve a target concentration. A pump pulls gas through the flow divider. In some embodiments, the flow divider setting is selected by the controller based on the NOx level measured after gas mixing. This enables the system to accommodate varying levels of NO/NO₂ gas flowing through the return gas path.

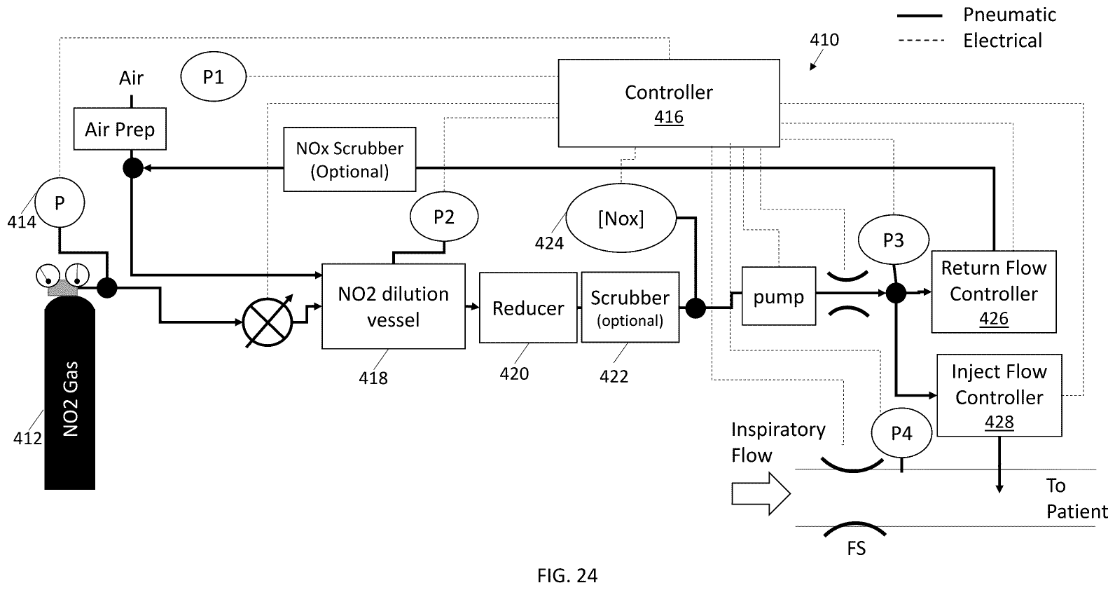

FIG. 24 depicts another exemplary embodiment of a system 410 that sources NO₂ from a gas cylinder 412. The concentration in the NO₂ cylinder can be selected from a range of concentrations, depending on the desired output NO concentration. In some embodiments, the NO₂ gas is pure. In some embodiments, the NO₂ gas is supplied in a balance of air. In some embodiments, the NO₂ gas is supplied in a balance of nitrogen. The output pressure of the cylinder is measured by a sensor 414 that is monitored by the controller 416 to ensure adequate supply and to inform the control of a NO₂ flow controller to achieve target flow rate. In some embodiments, in the event that the NO₂ source pressure falls below a threshold, an alarm is generated. The system utilizes a pump to draw NO₂ gas and ambient air into a dilution vessel 418. In some embodiments, the dilution vessel is simply tubing with no added volume. Gas exiting the dilution vessel passes through a reducer 420 (AKA a converter that converts NO₂ to NO) and an optional NO₂ scrubber 422 that removes any remaining NO₂. A NO sensor 424 measures the product gas concentration at the exit of the NO₂ scrubber. A flow sensor at the exit of the pump is utilized by the treatment controller as feedback to control the pump speed.

Various pressures can be calculated using measurements from a plurality of pressures sensors associated with the system. In some embodiments, a pressure sensor P1 is used to measure the ambient pressure. A pressure sensor P2 is used to measure a pressure associated with the NO₂ dilution vessel or container. The pressure head acting on the recirculation flow controller 426 is equivalent to a pressure measured by a pressure sensor P3 minus the ambient pressure from pressure sensor P1. The pressure head acting on the injection flow controller 428 is equivalent to the pressure sensor P3 minus the pressure within the inspiratory flow path, measured by a pressure sensor P4. The injection flow controller is opened by the controller to a level that flows a target amount of NO through the injector based on the delta-pressure across the flow controller. The recirculation flow controller is modulated to maintain a constant pressure at the outlet of the pump (pressure sensor P3). In some embodiments, the pump is located before the converter or between the converter and the NO₂ scrubber.

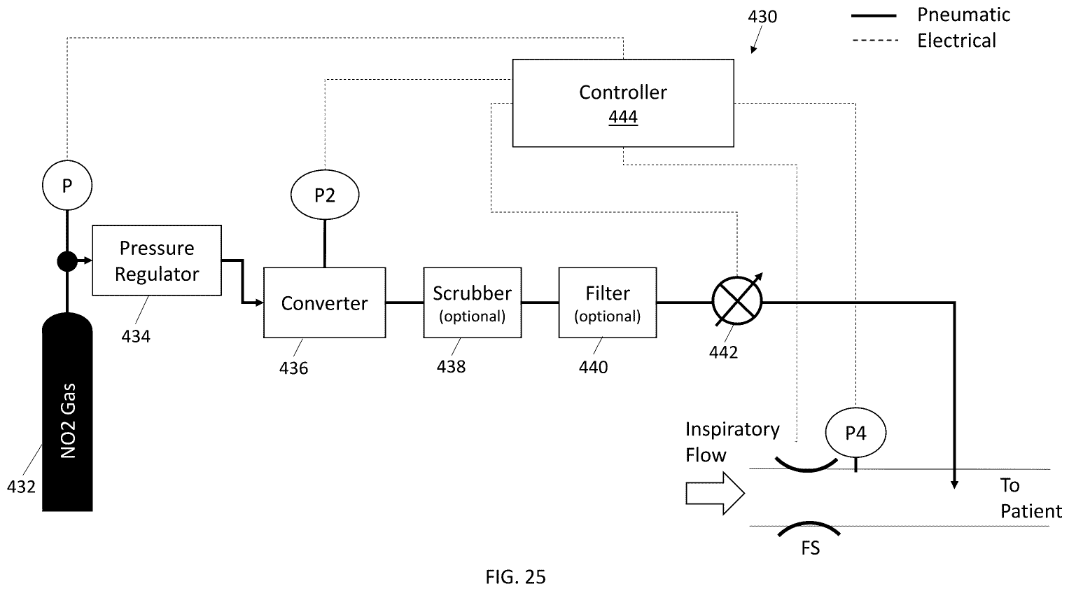

FIG. 25 depicts another embodiment of a system 430 that sources NO₂ gas from a compressed gas cylinder 432. In some embodiments, the NO₂ gas is pure NO₂. In some embodiments, the NO₂ gas is diluted with another gas (e.g., air, nitrogen, etc.). The gas pressure within the cylinder is reduced to an operating pressure with a regulator 434. After pressure regulation, the NO₂ gas enters a converter 436 that converts the NO₂ to NO. In some embodiments, an optional scrubber 438 removes any remaining NO₂ in the gas stream. An optional particle filter 440 removes any particulate matter that may be present in the product gas. Possible sources of particulate matter include the NO source material, the converter and the scrubber. Flow through the converter and scrubber is regulated by a flow controller 442. Gas exiting the flow controller is introduced into an inspiratory gas stream or delivered directly to a patient (e.g. nasal cannula). The operating pressure within the converter and scrubber, as maintained by the pressure regulator, is sufficient for the flow controller to deliver peak injection flows. The NO injection pulse parameters (flow rate, duration, delay, etc.) are determined by the controller based on one or more of NO gas concentration, inspiratory flow rate, prescribed patient dose, target portion of the breath to be dosed, and other factors. One or more of inspiratory flow rate and inspiratory pressure are measured by the controller 444 using sensors and serve as input into determining the flow rate and timing of NO delivery. In some embodiments, NO is delivered in pulses. In other embodiments, NO is delivered continuously. In some embodiments, NO is delivered at a constant flow rate. In some embodiments, NO is delivered proportionally with respect to an inspiratory flow rate.

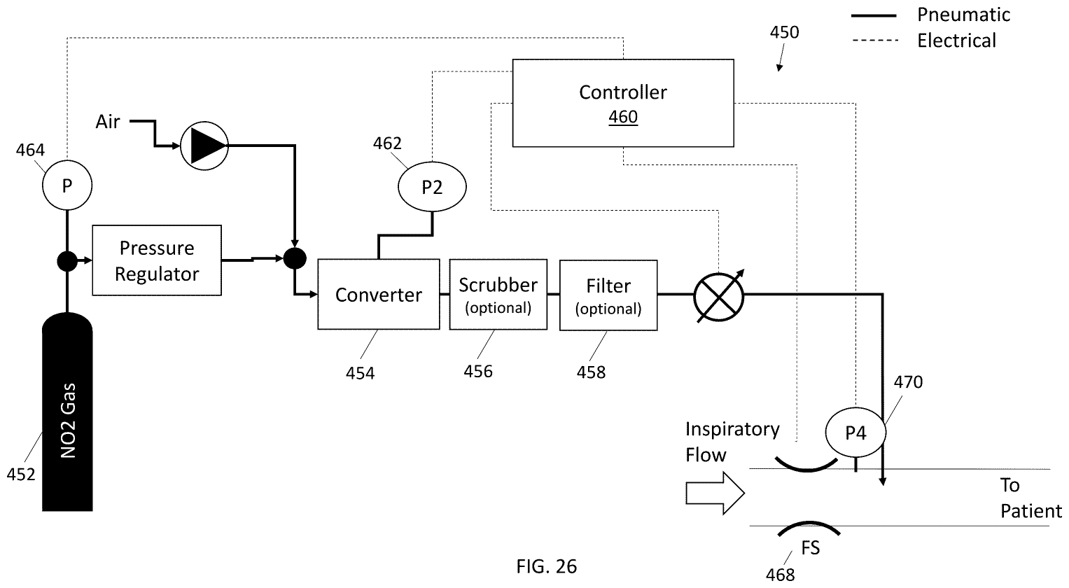

FIG. 26 depicts an embodiment of a NO delivery system 450 that derives the NO gas from a source 452 of NO₂ gas. The controller 460 is configured to control the dilution of the NO₂ gas by diluting the flow of NO₂ gas with air by controlling an air pump. The diluted NO₂ gas passes through a converter 454 to reduce the NO₂ to NO. An optional NO₂ scrubber 456 and particle filter 458 are used to further clean the NO product gas prior to injection in some embodiments. The controller 460 modulates the air source and NO₂ source to obtain a specific pressure and concentration of NO₂ gas entering the converter. The pressure of NO gas is measured by a sensor 462 in fluid communication with the NO gas. The controller 460 also monitors the pressure of the NO₂ source gas using a sensor 464. In some embodiments, the controller generates an alarm when the NO₂ pressure falls below a threshold. The controller uses the signal from one or more of a flow sensor 468 and a pressure sensor 470 to determine the target NO flow rate.

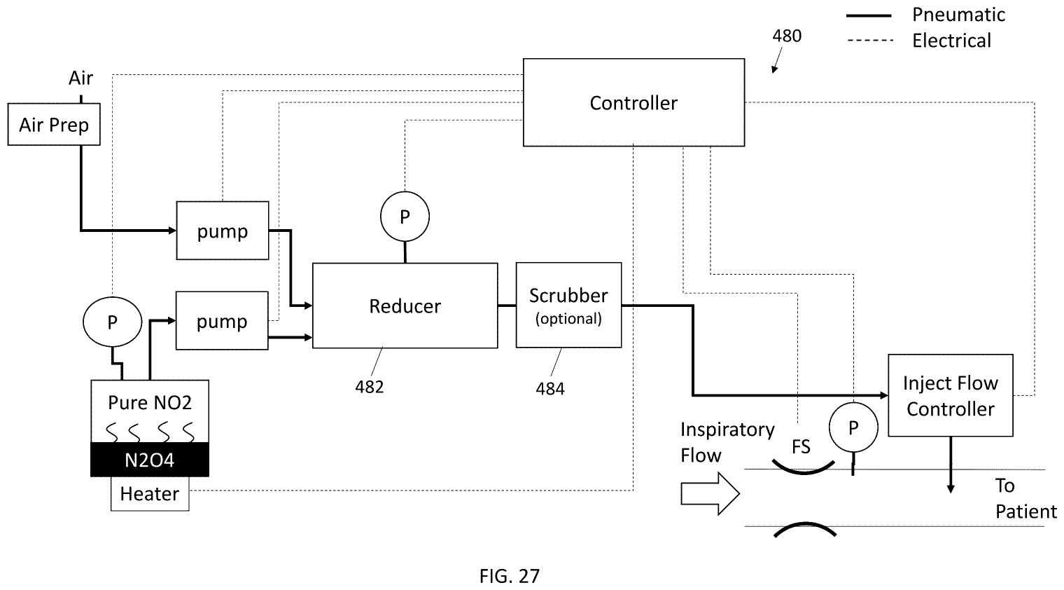

FIG. 27 depicts an exemplary embodiment of a system 480 that combines the dilution vessel and the converter. In this embodiment, NO₂ gas and dilution gas (air in this case) are introduced to a reducer or converter volume 482 in controlled amounts to generate a target concentration of NO gas at a known pressure. In some embodiments, the converter includes UV light that converts NO₂ to NO. In some embodiments, the converter includes heated metal (e.g. molybdenum, stainless steel) wire or mesh that strips oxygen from NO₂ to form NO. In some embodiments, ascorbic acid in the converter chamber reduces NO₂ to NO. In some embodiments, an optional NO₂ scrubber 484 is utilized to remove any remaining NO₂ from the gas flow. Flow is released from the pressurized reservoir according to the demands of the treatment. In some cases, NO gas flow is continuously released in proportion to a measured inspiratory flow. In some embodiments, NO is released intermittently in boluses to dose particular points of the respiration cycle (e.g., inspiration).

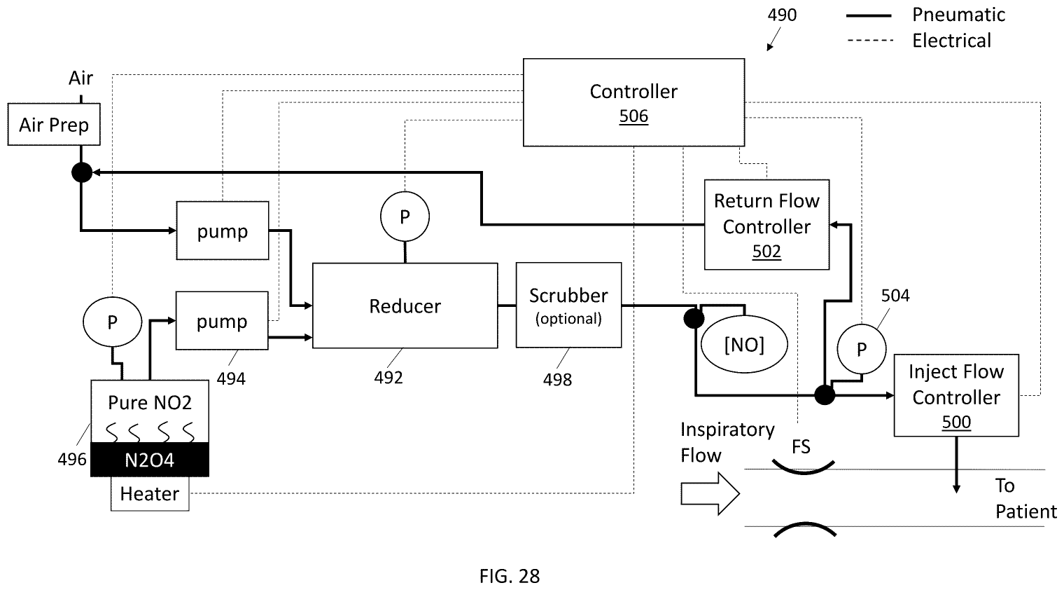

FIG. 28 depicts another embodiment of a system 490 that generates a variable flow of NO from a source of N₂O₄. A reducer or conversion chamber 492 converts NO₂ to NO. The conversion chamber 492 is supplied with a mixture of air and NO₂ gas, the mixture being variable by pumping effort of two independent pumps. The NO₂ pump 494 is supplied with NO₂ gas within the headspace of a N₂O₄ reservoir 496. When the gas exits the converter, the gas is optionally scrubbed of any remaining NO₂ using a scrubber 498 (e.g., soda lime scrubber) and the concentration of NO is measured by a sensor. The gas path bifurcates to either an injection flow controller 500 or a return flow controller 502. Pressure at the bifurcation is measured using a sensor 504 and serves as an input to the mass flow controllers. The injection flow controller is driven by the system controller to deliver a specific NO dose profile to an inspiratory flow stream. In some embodiments, the flow of NO is continuous and proportional to the measured inspiratory flow rate. In some embodiments, the NO flow is intermittent and/or pulsatile. The return flow controller is utilized to maintain pressure at the inlet of the NO injection flow controller. In some embodiments, the pressure before the NO injection flow controller is maintained at a constant pressure. Gas that passes through the return flow controller is introduced to the incoming air flow and passes through the system again.

Treatment with the system depicted in FIG. 28 is directed by a controller 506. In some embodiments, the controller receives a target inhaled NO concentration from a user. In some embodiments, the controller is programmed to deliver a specific concentration that is not user-adjustable. The controller modulates the temperature within the N₂O₄ reservoir based on a pressure measurement of the NO₂ gas. The controller also directly controls the pumps. By varying the pump activity independently, the controller can generate a wide range of flow rates and NO concentrations within the system. It will be understood that any of the controllers shown in the embodiments described herein can perform the functions as described in relation to the controller 506.

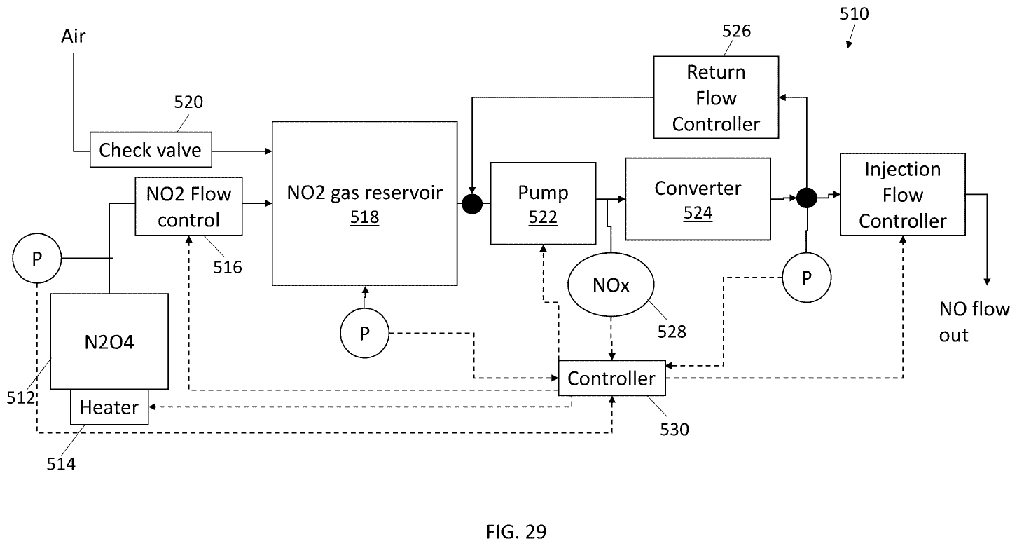

FIG. 29 depicts another embodiment of a system 510 that generates a continuously variable flow of NO from a source of N₂O₄ in an N₂O₄ reservoir 512. The pressure within a headspace in fluid communication with liquid N₂O₄ is controlled by the controller by modulating a heater 514. A flow controller 516 (e.g., mass flow controller, pump, etc.) permits an amount of the NO₂ gas to flow into an NO₂ reservoir 518, where it is diluted by air. The air enters the NO₂ gas reservoir through a check valve 520, making up for a difference between the flow rate of the pump and the flow rate of NO₂ entering the reservoir. The concentration of NO₂ within the reservoir is the result of the ratio of pure NO₂ gas and air that enters the reservoir. This ratio is controlled by the pump effort and the NO₂ flow controller.

The NO₂ gas passes through a pump 522 and passes through a converter 524 (e.g. ascorbic acid) where it is converted to NO gas. In some embodiments (not shown), an NO₂ scrubber is utilized to remove any remaining NO₂ from the gas stream after the conversion process. NO gas exits the system through a NO flow controller under the direction of the controller. All remaining NO gas that does not get injected passes through a return flow controller 526 and re-enters the gas pathway before the pump. In some embodiments, the return flow controller is controlled by the system controller to maintain a constant pressure at the NO injection controller. In many cases, this results in the two flow controllers operating in opposite directions. For example, when the NO injector opens to deliver a fast flow of NO, the return flow controller partially closes to maintain pressure pre-NO injector. As NO leaves the system, additional NO₂ gas is drawn into the recirculation loop by the pump. The concentration of NOx pre-converter is measured by a sensor 528. The controller 530 varies the NOx concentration by varying the ratio of air to pure NO₂ that enters the recirculation loop. In some embodiments, the concentration of NO in the gas post-converter is measured (not shown) by the controller. The controller utilizes the gas concentration, gas pressure and target NO gas flow rate in determining the degree of opening in the NO injection flow controller. It should be noted that any oxidation of NO to NO₂ in the return pathway is not a concern because the NOx concentration remains constant within the recirculation loop and NOx gas is converted to pure NO prior to injection.

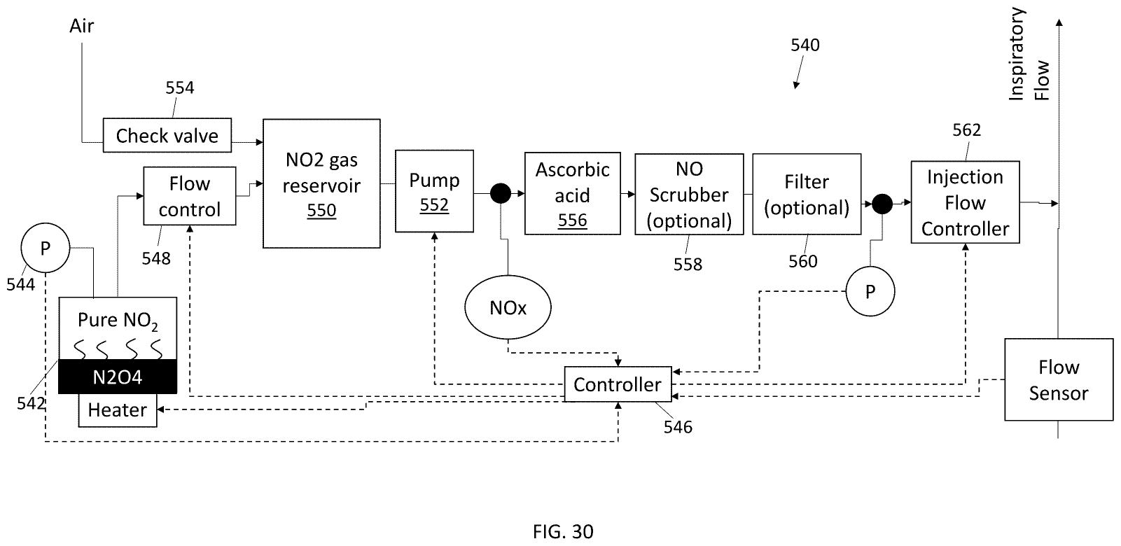

FIG. 30 depicts another embodiment of a system 540 that generates NO from an N₂O₄ source. N₂O₄ is heated to fill a headspace with NO₂ at a target pressure in a reservoir 542, as indicated by a pressure sensor 544. The device controller 546 uses the pressure measurement as an input to a control loop to maintain the NO₂ gas in the headspace at the target pressure. The controller utilizes a flow controller 548 (e.g. proportional valve, mass flow controller, PWM-controlled binary valve) to release pressurized NO₂ gas from the NO₂ headspace into an NO₂ reservoir 550. A pump 552 draws gas from the NO₂ reservoir. The speed of the pump is controlled by the controller. In some embodiments, the pump speed is constant.

The gas mixture removed by the pump includes NO₂ gas with make-up air flow, as required. Air flow enters the NO₂ reservoir passively through a check valve 554. The check valve prevents loss of NO₂ to the atmosphere. The concentration of the NO₂ gas is measured as it exits the NO₂ reservoir. The controller can vary the NO₂ concentration within the reservoir by varying the ratio of pure NO₂ gas to air entering the reservoir. Diluted NO₂ gas flows from the pump through an ascorbic acid chamber 556 that converts the NO₂ to NO. The NO gas passes through an optional NO₂ scrubber 558 to remove any remaining NO₂ and an optional particle filter 560 to remove any particulate from the ascorbic acid, NO₂ scrubber, or other components of the system.

The controller 546 receives a signal from a flow sensor in fluid communication with an inspiratory gas flow. The controller determines a quantity of NO to introduce to the inspiratory flow. In some embodiments, the quantity of NO introduced is proportional to the inspiratory flow rate. The controller delivers a specific quantity of NO by modulating the injection flow controller 562 based on one or more of the concentration of NO, pressure of NO, and calibration of the flow controller. In some embodiments, the controller utilizes data from a NO concentration sensor (not shown) located immediately upstream of the injection flow controller to know the concentration of NO product gas.

A pressure sensor in fluid communication with the outlet of the scrubber is utilized by the controller to quantify the NO gas pressure. The controller utilizes the NO gas pressure, NO gas concentration and target NO gas flow profile as inputs to controller the NO flow controller. In some embodiments, the concentration of NO at the injector is calculated based on the NOx gas concentration and known characteristics of the reducer and scrubber. In other embodiments, the NO gas concentration is directly measured by a sensor (not shown). In some embodiments, there is a particle filter (not shown) that removes particulate from the ascorbic acid, NO₂ scrubber material and other sources prior to or just after the NO injector.

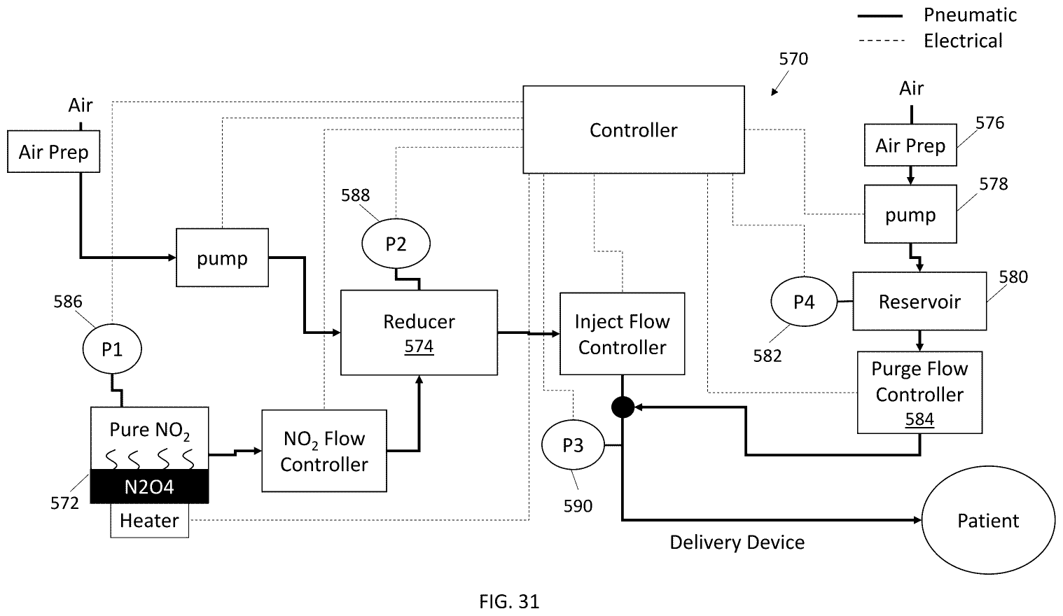

FIG. 31 depicts another exemplary embodiment of a system 570 with a pressurized conversion chamber. In this embodiment, NO₂ gas within the N₂O₄ chamber 572 is pressured to a level that exceeds the pressure within the conversion reservoir 574 so that gas passively moves through a flow controller and into the dilution chamber.

In this embodiment, purge gas is used to push the reduced NO₂ gas (i.e. NO gas) through a delivery system. The purge gas enables a system to rapidly deliver boluses of NO gas and clears the delivery tube of NO/NO₂ between boluses to prevent NO oxidation. In some embodiments, the purge gas is air. In some embodiments, the purge gas is an inert gas (e.g., N₂, CO2, Ar). In this specific embodiment, purge gas is sourced from the environment and passes through a treatment stage 576. In some embodiments, the treatment stage includes one or more of particle filtration, humidity management, NOx scrubbing, and VOC scrubbing. The gas then passes through a pump 578 that pressurizes a reservoir 580 with purge gas. The purge gas reservoir pressure is measured by the controller using pressure sensor 582 (P4). The target pressure within the purge reservoir is selected such that the purge reservoir can deliver the required volume of gas to purge the system (e.g. NO delivery system, cannula, mask, Scoop catheter, inspiratory limb) within a required amount of time. In one example, a purge reservoir is pressurized to 10 psi and is utilized to purge a 40 ml delivery system in 30 milliseconds. In some embodiments, the purge gas reservoir includes an active or passive pressure-release feature that protects the reservoir from over-pressurization (not shown). A flow controller 584 downstream of the purge gas reservoir controls the flow of purge gas exiting the reservoir. There are multiple pressure sensors within the system. A pressure sensor 586 (P1) measures the pressure of NO₂ gas in the N₂O₄ chamber. A pressure sensor 588 (P2) measures the pressure within the NO₂ reducing chamber. A pressure sensor 590 (P3) measures the pressure within the delivery system. In some embodiments, the pressure sensor 590 (P3) is utilized to monitor patient respiratory activity and detect events to the dosed. The pressure sensor 582 (P4) measures the pressure within the purge gas reservoir.

Depending on the concentration of NO and the desired dose, the quantity of NO delivered to the patient in a bolus can be, for example, 10 ml to 50 ml. The volume of purge gas delivered is only the amount required to displace the NO gas from the NO device and delivery system (i.e., the internal volume of the delivery system). In the case of a nasal cannula, this volume is on the order of 30 to 50 ml. Those skilled in the art of NO delivery can appreciate that the pump shown to deliver NO₂ to the conversion chamber could be replaced with a flow controller that permits high pressure NO₂ gas to enter the reducer.

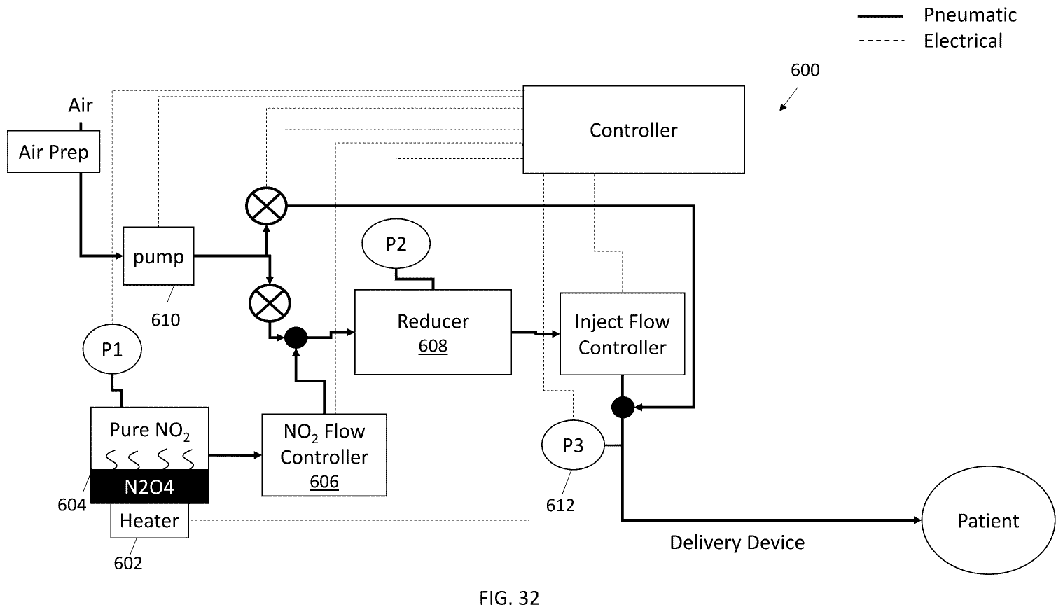

FIG. 32 depicts an embodiment of a NO delivery system 600 that sources NO from N₂O₄. NO₂ gas is generated by heating N₂O₄ in a reservoir 604 using a heater 602. Pressurized NO₂ is released through a flow controller 606 into a flow of air. The diluted NO₂ gas flow enters a reducer 608 that converts NO₂ to NO. A pump 610 that induces air flow into the reducer chamber generates pressure within the reducer chamber when the NO flow controller is closed. NO is released from the system through a NO flow controller where it passes through a delivery device to a patient. Air flow from the pump can also be directed directly to the delivery device to purge the delivery device of NO and NO₂. Purging occurs when the controller opens a valve to permit purge gas to flow. In some embodiments, the delivery device is purged at the conclusion of a patient treatment. In some embodiments, the delivery device is purged between each delivery of pulsed NO. A pressure sensor 612 (P3) is utilized by the controller to detect patient respirations as an input to determining when to delivery NO.

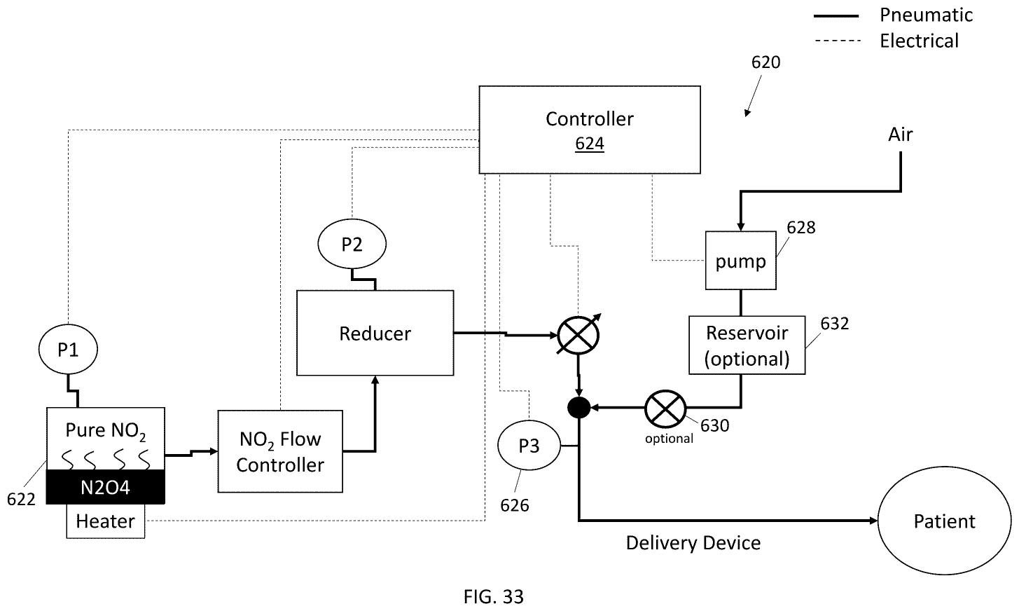

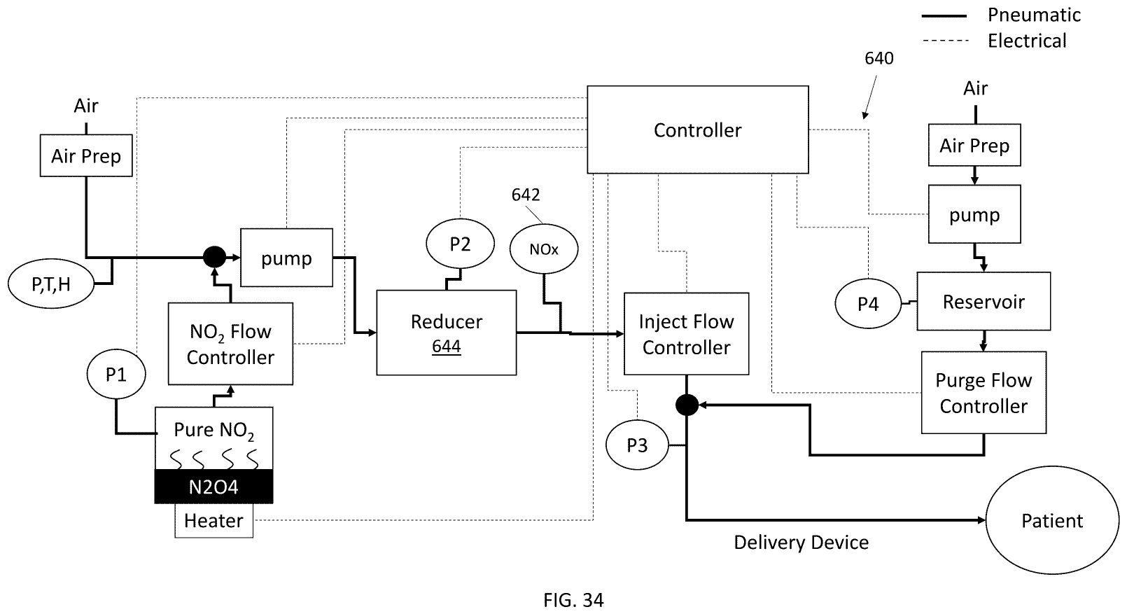

FIG. 33 depicts another embodiment of a NO delivery system 620 with a purging feature. NO gas is soured from an NO₂ gas flow from heated liquid N₂O₄ in a reservoir 622. The controller 624 introduces NO gas to the delivery device according to event timing detected from a pressure sensor 626 (P3). The controller modulates the NO flow using a flow controller. In some embodiments, purge gas flow is propelled by a pump 628. In some embodiments, purge gas is sourced from an external pressurized source (not shown) and the pump is not required. The controller 624 controls the flow of purge gas by controlling one or more of the pump 628 and an optional flow controller 630. In some embodiments, the pump runs continuously at a constant flow rate to minimize acoustic noise generation. Purge gas accumulates and is released from the reservoir 632 at the direction of the controller. In some embodiments, the controller purges the delivery device at or more of the end of each NO pulse and the end of each NO treatment.

FIG. 34 depicts another exemplary embodiment of a NO delivery device 640 with purge feature that introduces controlled amounts of NO₂ gas to a dilution gas flow prior to the NO₂ pump. This approach allows for one fewer pump which can reduce mass and sound generation of the system. An optional NOx or NO sensor 642 measures the actual concentration of the NO product gas exiting the reducer 644. In some embodiments (not shown), a NO₂ or NOx sensor measures the concentration of gas entering the reducer. Based on the characteristics of the reducer, the controller can predict the concentration of NO exiting the reducer. The known NO concentration is utilized by the controller to determine a flow rate and/or bolus volume (for pulsed delivery) that will accurately dose the patient.

Furfural Scrubbing

It is common to use ascorbic acid (Vitamin C) to convert NO₂ to NO. Ascorbic acid is known to degrade into furfural, a toxic compound. In some applications, the degradation of ascorbic acid is accelerated by a strongly acidic environment, as can be caused by NO₂ in an aqueous environment forming nitric acid. Degradation of ascorbic acid can also be accelerated by elevated temperature, hence thermal isolation of an ascorbic acid-based converter from an N₂O₄ heating element can allow for minimizing ascorbic acid degradation.

In some embodiments, an ascorbic acid scrubber is packaged with buffer materials (e.g. salts) or alkaline materials to mitigate against the pH decreasing and subsequent formation of furfural in the gas pathway. In some embodiments, the NO gas stream post-conversion process is scrubbed for furfural to prevent the furfural from reaching the patient. An ideal furfural scrubber removes furfural without affecting the concentration of NO in the gas. In one embodiment, product gas passes through an activated carbon scrubber to remove furfural and other VOCs with little to no effect on NO concentration.

All patents, patent applications, and published references cited herein are hereby incorporated by reference in their entirety. It will be appreciated that several of the above-disclosed and other features and functions, or alternatives thereof, may be desirably combined into many other different systems or application. Various alternatives, modifications, variations, or improvements therein may be subsequently made by those skilled in the art.

What is claimed is:

1. A system for generating nitric oxide (NO), comprising:
a converter configured to convert a source material to a NO-containing gas;
at least one controller configured to independently control a conversion of the source material to the NO-containing gas and a delivery of the NO-containing gas to an inspiratory pathway; and
one or more sensors configured to communicate, to the at least one controller, information related to the conversion of the source material to the NO-containing gas, at least one of the one or more sensors comprising a pressure sensor to measure a pressure related to gas released by the source material.

2. The system of claim 1, wherein the converter comprises a first stage configured to convert the source material to an intermediate material and a second stage configured to convert the intermediate material to the NO-containing gas.

3. The system of claim 2, wherein the source material is N₂O₄ and the intermediate material is NO₂.

4. The system of claim 3, wherein the first stage of the converter includes a heater that is configured to heat the N₂O₄ to convert the N₂O₄ into NO₂.

5. The system of claim 3, wherein the second stage of the converter includes ascorbic acid that is configured to convert the NO₂ into the NO-containing gas.

6. The system of claim 5, further comprising a dilution gas configured to dilute the NO₂ before exposure to the ascorbic acid in the second stage of the converter.

7. The system of claim 6, wherein the dilution gas is ambient air.

8. The system of claim 4, wherein the controller is configured to receive the pressure measurement from the pressure sensor and use the pressure measurement as feedback to control the N₂O₄ heater.

9. The system of claim 3, wherein the controller is configured to receive the pressure measurement from the pressure sensor and use the pressure measurement as feedback to an NO₂ flow controller to control the flow of NO₂ to the second stage of the converter.

10. The system of claim 2, wherein the first stage of the converter comprises a heated chamber, and wherein the heated chamber includes a piston for pressure control in a gas headspace of the heated chamber.

11. The system of claim 2, wherein the second stage of the converter comprising at least one of an antioxidant material, a nitroxyl material, an enzyme, radiation, and a catalytic reaction to convert the intermediate material into the NO-containing gas.

12. The system of claim 1, further comprising a mixing chamber configured to blend the NO-containing gas with gas in the inspiratory pathway prior to inhalation.

13. The system of claim 1, wherein the controller is configured to control delivery of the NO-containing gas to the inspiratory pathway such that a mass flow of the NO-containing gas into an inspiratory limb of a ventilator circuit is in proportion to a inspiratory gas mass flow rate.

14. The system of claim 1, wherein the one or more sensors further measure at least one of a temperature in the converter, a humidity condition in the converter, a pressure related to the converter, a gas flow rate, a NO concentration in the NO-containing gas produced by the converter, and reagent quantities of the source material.

15. The system of claim 2, wherein the one or more sensors further measure at least one of a temperature in the converter, a humidity condition in the converter, a pressure related to gas within the converter, a gas flow rate, a NO₂ concentration, a NO concentration in the NO-containing gas produced by the converter, and reagent quantities of the source material.

16. A method of generating nitric oxide (NO), comprising:
converting a source material, using a converter, to a NO-containing gas;
measuring, using one or more sensors, a pressure related to gas in the converter;
controlling, using at least one controller, a conversion of the source material to the NO-containing gas utilizing the measured pressure; and
controlling, using the at least one controller and independent of the controlling of the conversion of the source material to the NO-containing gas, delivery of the NO-containing gas to an inspiratory pathway.

17. The method of claim 16, wherein converting the source material to the NO-containing gas comprises converting the source material to an intermediate material and converting the intermediate material to the NO-containing gas.

18. The method of claim 17, wherein the source material is N₂O₄.

19. The method of claim 17, wherein the intermediate material is NO₂.
